(19) United States
(12) Patent Application Publication
(10) Pub. No.: US 2026/0274453 A1
(43) Pub. Date: Sep. 17, 2026

(54) WORKSTATION FOR MICROGRAVITY ENVIRONMENTS

(71) Applicant: SATED Space LLC, Boulder, CO (US)

(72) Inventor: James Thomas Sears, Boulder, CO (US)

(21) Appl. No.: 19/678,073

(22) Filed: May 14, 2026

Related U.S. Application Data
(63) Continuation-in-part of application No. 19/311,297, filed on Aug. 27, 2025.
Application No. 19/311,297 is a continuation of application No. 18/457,272, filed on Aug. 28, 2023, now Pat. No. 12,434,865.
(60) Provisional application No. 63/401,396, filed on Aug. 26, 2022.
(60) Provisional application No. 63/805,617, filed on May 14, 2025.

(51) Int. Cl. B64G 4/00; B01D 46/10; B01D 46/48

(52) U.S. Cl. CPC B64G 4/00; B01D 46/10; B01D 46/48

(57) ABSTRACT

A workstation for microgravity environments is provided that prevents objects from floating around inside a spacecraft. The workstation includes a downdraft table that has a plenum chamber with an inlet and an outlet. A fan is disposed in the plenum chamber for drawing air into the plenum via the inlet, and exhausting air from the plenum via the outlet. A metal grate is disposed across the inlet, and an air resistive stack is disposed on an outer side of the metal grate. The air resistive stack includes an inner resistive layer disposed on the metal grate and an outer resistive layer disposed on the inner layer. The workstation improves a user's ability to perform many activities in a microgravity environment.

### CROSS-REFERENCE TO RELATED APPLICATIONS

This application claims the benefit of priority of U.S. Provisional Patent Application No. 63/805,617 filed May 14, 2025. This application is also a Continuation-in-Part of U.S. patent application Ser. No. 19/311,297 filed Aug. 27, 2025, which is a Continuation of U.S. patent application Ser. No. 18/457,272 (now U.S. Pat. No. 12,434,865) filed Aug. 28, 2023, which claims the benefit of priority of U.S. Provisional Patent Application No. 63/401,396 filed Aug. 26, 2022. Each of the above-referenced applications is incorporated herein by reference in their entireties.

### BACKGROUND

### Field

The disclosed embodiments relate generally to the field of spaceflight microgravity environments. More specifically, the disclosed embodiments relate to a workstation device for assisting people in spaceflight microgravity environments.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

In an embodiment, a workstation for microgravity environments, includes: a downdraft table, including: a plenum chamber having an inlet and an outlet; a fan disposed in the plenum chamber, wherein the fan is configured to draw air into the plenum via the inlet and exhaust air from the plenum via the outlet; a metal grate disposed across the inlet; and an air resistive stack disposed on an outer side of the metal grate, wherein the air resistive stack includes: an inner resistive layer disposed on the metal grate; and an outer resistive layer disposed on the inner layer.

### BRIEF DESCRIPTION OF THE DRAWINGS

Illustrative embodiments of the present disclosure are described in detail below with reference to the attached drawing figures, which are incorporated by reference herein and wherein:

FIG. 1A depicts a spacecraft in orbit around the Earth configured to provide a microgravity environment onboard;

FIG. 1B illustrates a microgravity environment aboard the International Space Station (ISS);

FIG. 2A illustrates how microgravity is achieved through aircraft parabolic flight maneuvers;

FIG. 2B illustrates a microgravity environment during parabolic flight;

FIG. 3 illustrates exemplary spacecraft trajectories in deep space;

FIG. 4 shows exemplary foot restraints on the ISS;

FIG. 5A shows a meal table on the ISS;

FIG. 5B shows exemplary food packaging for spaceflight missions;

FIG. 6A shows a prior art low restriction downdraft table for dust capture;

FIG. 6B is a schematic view of a low restriction downdraft table, in an embodiment;

FIG. 6C shows a prior art high restriction downdraft table for holding down objects;

FIG. 7 shows a downdraft table with fabric resistive layers, in an embodiment;

FIG. 8A is a perspective view of a downdraft table with resistive layers pulled back, in an embodiment;

FIG. 8B is a side view of a downdraft table of FIG. 8A;

FIG. 8C shows a retention force experiment setup;

FIG. 9A lists downdraft table specifications, in an embodiment;

FIG. 9B lists downward force versus lift-off distance for various objects;

FIG. 9C lists pressure and electrical power for different flow resistive layers;

FIG. 9D illustrates various objects tested for use with the downdraft table;

FIG. 10 shows a downdraft table with an outflow resistive layer, in an embodiment;

FIG. 11 illustrates the downdraft table of FIG. 10 being used to capture generated debris;

FIG. 12 illustrates the downdraft table of FIG. 10 with a resistive filter layer fully loaded with debris;

FIG. 13 illustrates the downdraft table of FIG. 10 with a covering resistive filter layer having a sealing layer, in an embodiment;

FIG. 14 illustrates the downdraft table of FIG. 10 with debris captured in a power off mode;

FIG. 15 illustrates the downdraft table of FIG. 10 with safe removal of a fouled outer resistive layer in microgravity;

FIG. 16 illustrates the downdraft table of FIG. 10 prepared for laying down a fresh outer resistive filter layer;

FIG. 17 shows three views of a downdraft cubby, in an embodiment;

FIG. 18 shows the downdraft cubby of FIG. 17 installed on the downdraft table of FIG. 10;

FIG. 19 shows the downdraft cubby of FIG. 18 having objects therein;

FIG. 20 shows the microgravity downdraft workstation of FIG. 10 having a padded blade saddle, in an embodiment;

FIG. 21A shows a Skylab space station foot and a thigh restraint microgravity workstation;

FIG. 21B is a side view of a prior art knee pressure grip microgravity restraint concept;

FIG. 21C is a perspective view of the prior art knee pressure grip microgravity restraint concept of FIG. 21B;

FIG. 22A is a perspective view of the microgravity downdraft workstation having a padded blade saddle, in an embodiment;

FIG. 22B is another view of the microgravity downdraft workstation having the padded blade saddle of FIG. 22A;

FIG. 23A is a side view of a padded blade microgravity saddle, in an embodiment;

FIG. 23B is a cross-section view of the padded blade microgravity saddle of FIG. 23A;

FIG. 23C is another cross-section view of the padded blade microgravity saddle of FIG. 23A;

FIG. 24 shows a microgravity environment workstation having a downdraft table and a padded blade microgravity saddle mounted to the downdraft table, in an embodiment; and

FIG. 25 is a perspective view of the microgravity environment workstation of FIG. 24 having a plurality of padded blade microgravity saddles, in an embodiment.

FIG. 26A is a perspective view of a backwards curved impeller blower, in embodiments.

FIG. 26B is a schematic diagram of the blower of FIG. 26A.

FIG. 26C is a side view of the blower of FIG. 26A.

FIG. 26D is a block diagram of a controller for controlling the blower of FIG. 26A.

FIG. 27 is a side view of another embodiment of a cubby for use with a downdraft table, in embodiments.

FIG. 28 is a perspective view of the cubby of FIG. 27.

FIG. 29 is a top view of the cubby of FIG. 27.

FIG. 30 is a top view of the cubby of FIG. 27.

FIG. 31 is a side perspective view of the cubby of FIG. 27 showing airflow, in embodiments.

FIG. 32 is a partial perspective view of a filter for use with the cubby of FIG. 27.

FIG. 33A is a side view of a downdraft table for additive manufacturing, in embodiments.

FIG. 33B is a top view of the downdraft table of FIG. 33A.

FIG. 33C is a side view of the downdraft table of FIG. 33A.

FIG. 34 is a side view of another embodiment of the cubby of FIG. 27, in embodiments.

FIGS. 35A-35B are side views of the cubby of FIG. 34 and an independent power unit, in embodiments.

FIG. 36 is a schematic diagram of another embodiment of a downdraft workstation.

FIG. 37 is a schematic diagram of a distributed module workstation, in embodiments.

FIG. 38A is a schematic diagram of a ducted tube-axial fan, in embodiments.

FIG. 38B is a schematic diagram of a ducted tube-axial counter-rotating fan, in embodiments.

FIG. 38C is a schematic diagram of a ducted centrifugal fan, in embodiments.

FIG. 39 is a schematic diagram of a fire-safe fines filter, in embodiments.

FIG. 40A is a side cross-section of self-sealing fines filter in open mode, in embodiments.

FIG. 40B is a top view of filter sealing slats in open mode, in embodiments.

FIG. 40C is a side cross-section of self-sealing fines filter in closed mode

FIG. 40D is a top view of filter sealing slats in closed mode, in embodiments.

FIG. 41A is a diagram of a fines sealing filter in free-flow filtration mode, in embodiments.

FIG. 41B is a diagram of a fines sealing filter in sealed-mode, in embodiments.

FIG. 42 is a schematic diagram of the downdraft workstation of FIG. 40 with self-sealing fines filter, in embodiments.

FIG. 43 is a diagram of a self-sealing fines filter controller, in embodiments.

FIG. 44 is a schematic diagram of the downdraft workstation FIG. 40 with self-sealing filter in powered-down mode, in embodiments.

FIG. 45 is a schematic diagram of a cubby in-draft storage locker mated with self-sealing fines filter, in embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of the equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the technology can include a variety of combinations and/or integrations of the embodiments described herein.

### The Problem:

Astronauts have continuously inhabited the microgravity environment of low-earth orbit aboard the International Space Station (ISS) since October of 2000. Microgravity, for the purposes of this application, is defined as the environmental state in which objects do not fall in any direction relative to their local environment. This environment is experienced as weightlessness and often called zero-gravity even though the gravitational attraction between masses, well known in physics, is always in play anywhere in the universe. Therefore, the term “microgravity” is used in this application to describe environments when the prevailing effect of gravity is too small to be observed.

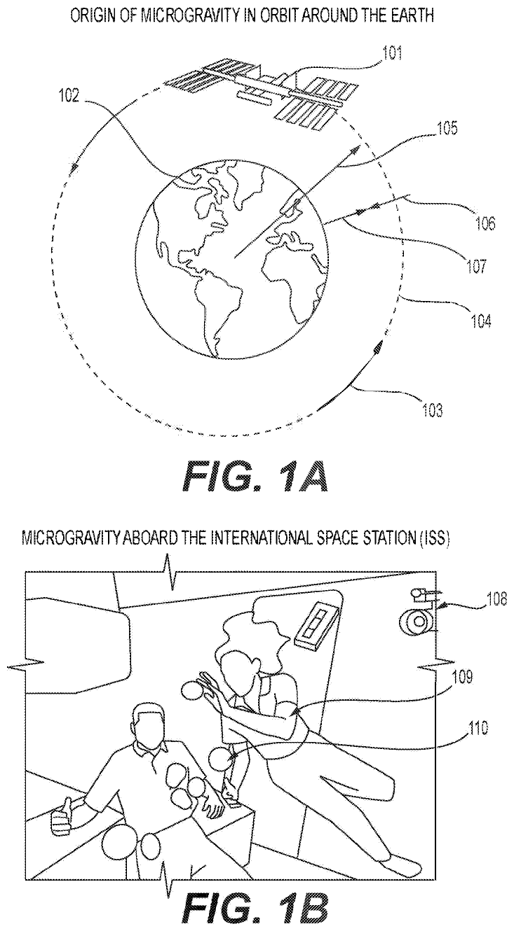

Microgravity exists aboard space stations orbiting the Earth because the centripetal acceleration due to the circular orbit exactly counterbalances the natural gravitational effect arising from the co-attraction of masses. Referring to FIG. 1A, an orbiting object such as the International Space Station (ISS) 101 orbits 103 along a circular path 104 at radius 105 around a large body of mass such as Earth 102. Radius 105 is approximately 6743 Km. The gravitational attraction of Earth 102 is classically expressed as an acceleration 107 of 9.8 meters/second2 aimed outwards from Earth as measured at the surface of the Earth. Because the ISS 101 orbit is positioned further from earth's center of mass than the surface, Earth's acceleration of gravity at the ISS itself is only 8.6 meters/second2. As the ISS 101 orbits 103 along circular path 104 it experiences centripetal acceleration 106 aimed toward the center of rotation. Microgravity on the ISS 101 occurs because its centripetal acceleration 106 exactly counterbalances the acceleration of gravity 107 at its location. Since everything and everyone aboard the ISS 101 is traveling the same circular orbit 104 everything and everyone experiences microgravity. FIG. 1 b shows a view of the interior of the ISS 108 in which an astronaut 109 is seen floating in the cabin and attempting to grab other floating objects 110 around her.

While floating in space looks fun, if the astronaut is seriously trying to keep control of many floating objects 110 then the experience can be overwhelming. Additionally, the astronaut 109 cannot control her own position or orientation in the cabin except by hooking a foot under a grab bar.

Accordingly, everything not bolted or tethered to the inside of the ISS 101 is traditionally stowed in tethered bags or clamped or Velcroed to an inside surface of the ISS 101. This poses a long prevailing problem as not everything is convenient to attach Velcro to or tie with a tether. For example, consider screws removed when repairing equipment, pieces of food not stuck to a utensil or a stack of playing cards that would start to float around during a game.

Aboard the ISS, microgravity is a constant experience that has now lasted almost 20 years. Astronauts living aboard the ISS have to attend to objects that may float around them causing constant grabbing of a food packet, tool or piece of clothing. To prevent mental and physical distraction aboard the ISS every individual object must be stowed away or attached to the interior of the ISS. Famously, adhesive spots of Velcro and elastic bands have been used extensively to hold down tools, writing instruments, food packets during mealtime and the multitude of objects of every sort needed during normal life. The present invention, among many other applications, aims to make equipment repair, eating food and playing cards aboard the ISS 101 or any microgravity environment possible.

However, a host of normal human activities are currently simply impossible aboard the ISS. Consider playing a hand of cards. Without a means to hold dealt cards to the table, 52 objects could begin floating about the cabin. Attaching a piece of Velcro to each card would make it impossible to shuffle. Opening a container of small objects would leave one scrambling to re-contain them. Removing more than one screw or part from a piece of equipment under repair leaves one with the time consuming task of restraining or containing each individual part. Some substances such as powders or granules are simply forbidden to handle aboard the ISS for risk not only of them spreading around the interior but also the dangerous possibility of inhaling them with normal medical care simply unavailable.

The list of impractical or dangerous practices aboard the ISS, that are normal on Earth, is formidable and an impairment to performing routine scientific duties and daily activities. Add to this that the astronauts themselves float around unless their shoes are strapped to the deck. This makes grabbing for objects that float away more difficult. More importantly it makes manual tasks requiring fine motor control difficult as the hands cannot be grounded by gravity holding one buttocks to a chair or forearms to a table.

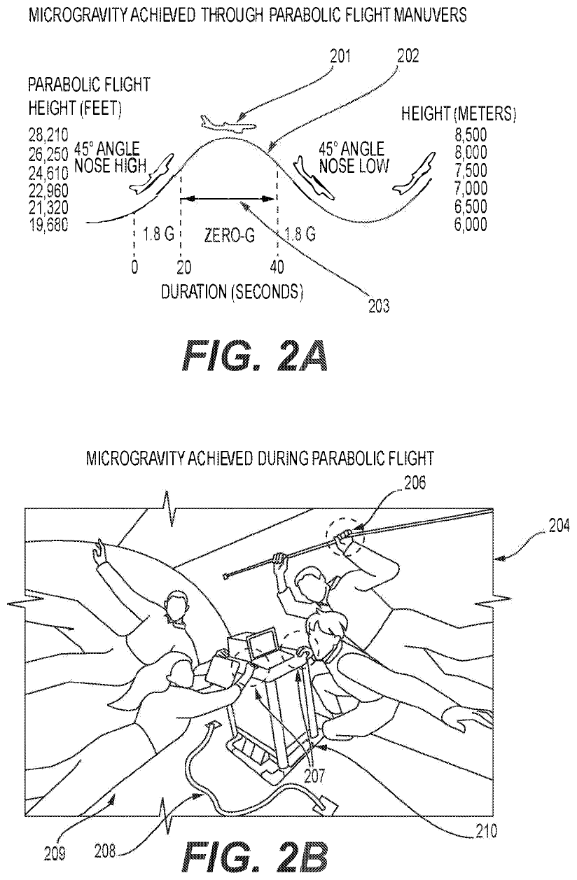

Referring to FIG. 2A, microgravity can also be experienced aboard conventional aircraft 201 performing parabolic flight maneuvers 202 wherein the aircraft is allowed to crest unpowered in its flight path for periods of up to about 20 seconds 203. During this 20 seconds, unrestrained objects and people float freely around the interior of the aircraft. These flights enable tourists to experience weightlessness and researchers use them to validate the performance of equipment destined for use aboard the ISS or other spacecraft. FIG. 2B shows a typical scene 204 of researchers 209 attempting to work on an experiment 210 during one of these zero-g flights. It is difficult to have both hands occupied on the work when the body is otherwise unconstrained. Researchers must hold onto stabilizing straps 206. Much wasted time and effort typically needs to be expended orienting one's body and holding onto equipment with one hand 207 while making adjustments with the other. Floor straps 208 are often fastened over the researchers' calves. Despite the considerable expense of these parabolic flight operations, the ability of the experimenter 209 to operate any experiment in microgravity is being tested more than the experiment 210 itself. Much time is wasted because of the lack of a way to control the researcher's body and floating objects during experimentation.

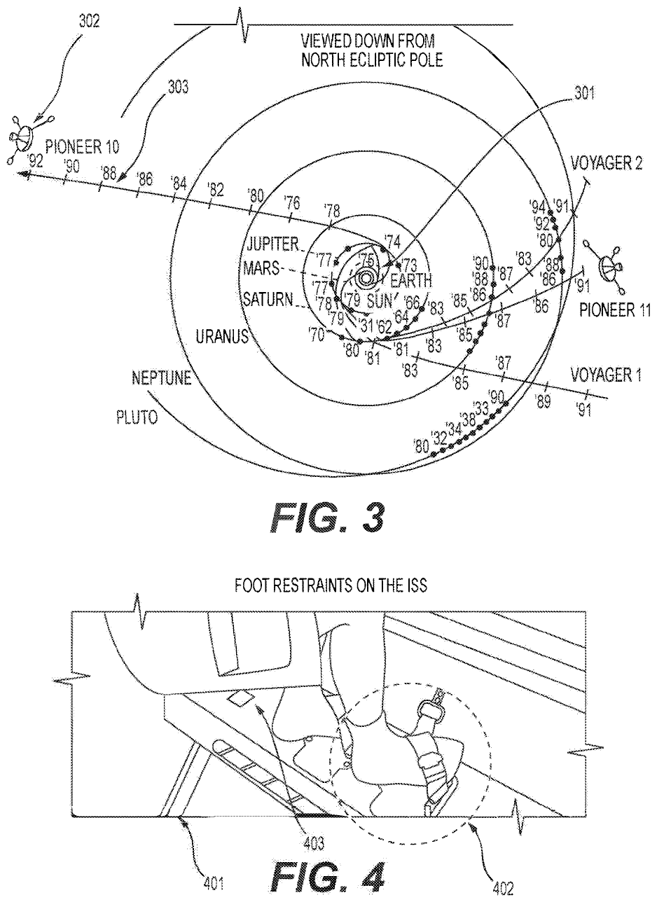

Microgravity also exists in deep space. FIG. 3 shows a view of our solar system and some of our exploration vehicles such as Pioneer-10 302 speeding along a path 303 further and further away from the earth, sun and other planets in our solar system having a gravitational attraction. The force of gravity decreases with the square of the distance away from the gravitational body. Even within the circle 301 that contains the Sun, Earth and Mars the reductions in gravity can be extreme because of the distances. For example, a spacecraft traveling within that circle 301 to Mars by the end of the decade would come to experience gravity at a level less than 1 millionth that on Earth. A spacecraft one day traveling beyond the orbit of Pluto would experience gravity at a level 1 trillionth of that on earth. Like being in orbit or on a parabolic flight aircraft, these deep space environments also need a way to stabilize the human body so it can easily do work and stabilize many parts at once from floating around so that complex tasks can be completed.

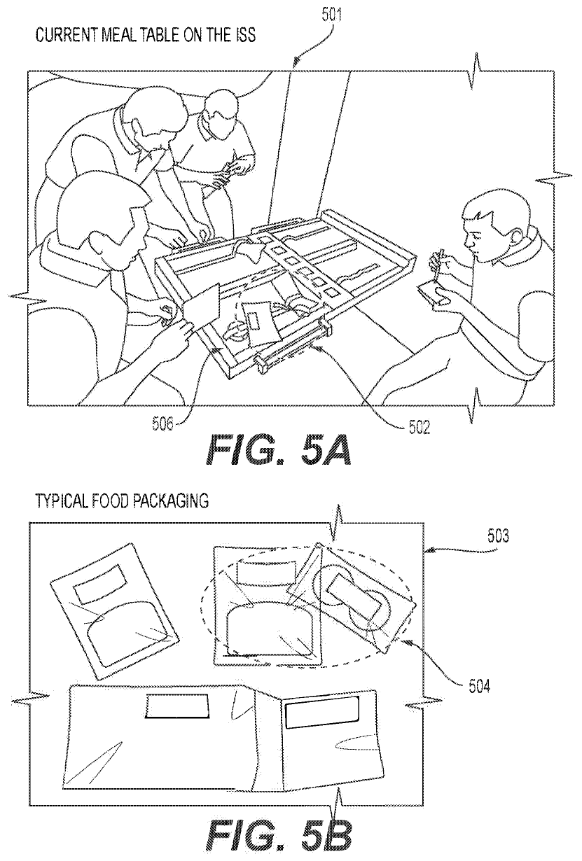

FIG. 4 shows the most common approach currently used to stabilize the body in microgravity. Throughout the work areas of the ISS 401 are located foot straps 402 that the astronaut 403 can use to keep themselves from floating away. When working with their hands, astronauts 403 must often brace their actions through their feet. This happens on an almost continuous basis so that astronauts are known for generating calluses on the tops of their feet from constant use of foot straps 402 like those shown in FIG. 4. FIG. 5A shows a meal table on the ISS. Objects 502 are held to the surface of table by strips of Velcro 506 or by Velcro dots affixed to the bottoms of objects 502. FIG. 5B shows exemplary food packaging for spaceflight missions.

What is needed in microgravity environments is a way to keep unattached objects, liquids, parts, ingredients and particles localized to a workstation desktop and a way for the astronaut to stabilize and orient themselves to the workstation in a way that does not require taking their hands from their work. The invention described in this application is a microgravity workstation combining a microgravity adapted downdraft table with a microgravity stabilizing seating solution.

### The Solution: a Microgravity Downdraft Table Plus Microgravity Seating Solution.

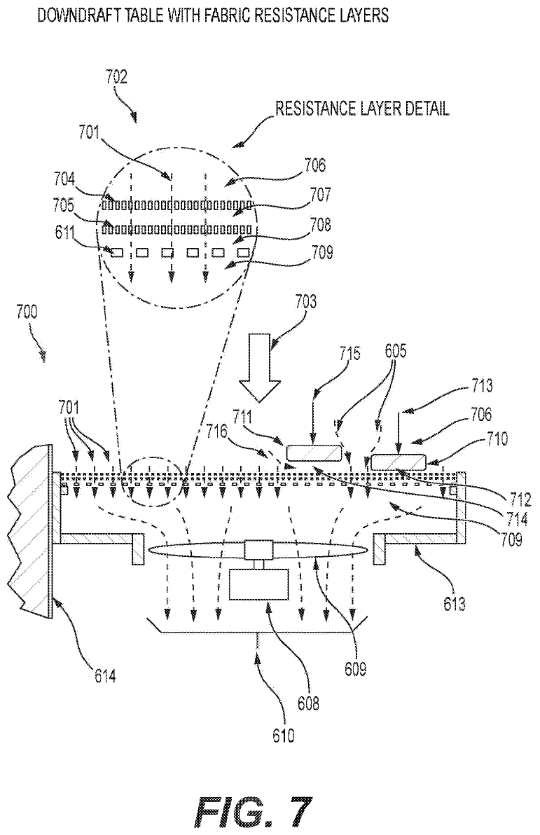

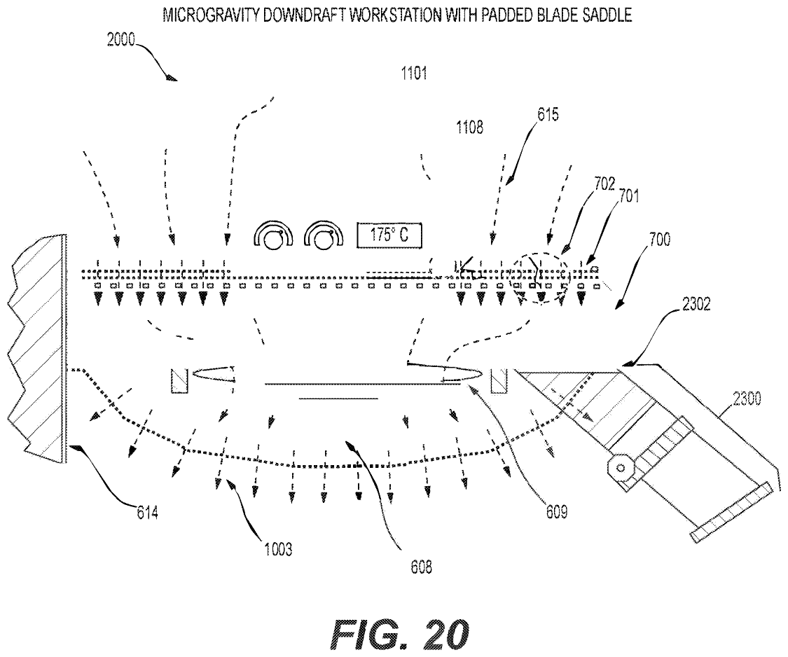

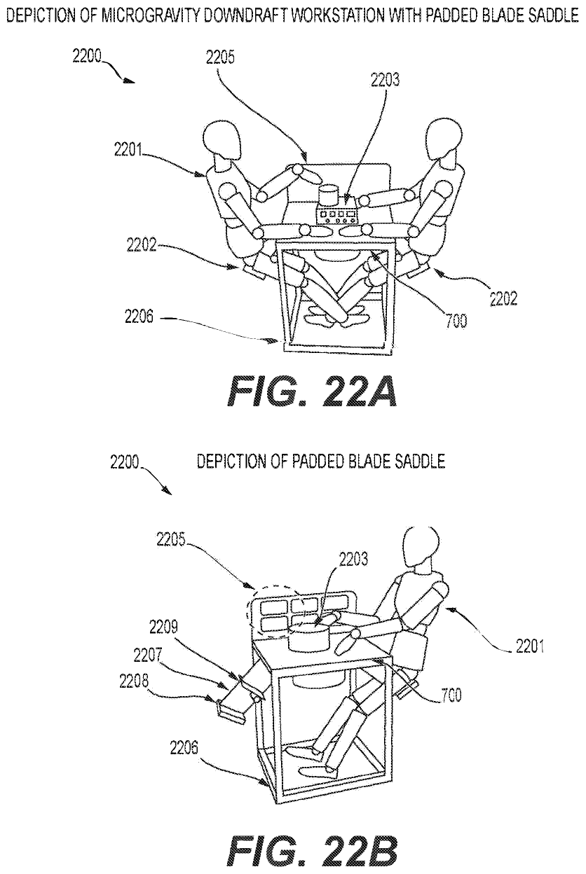

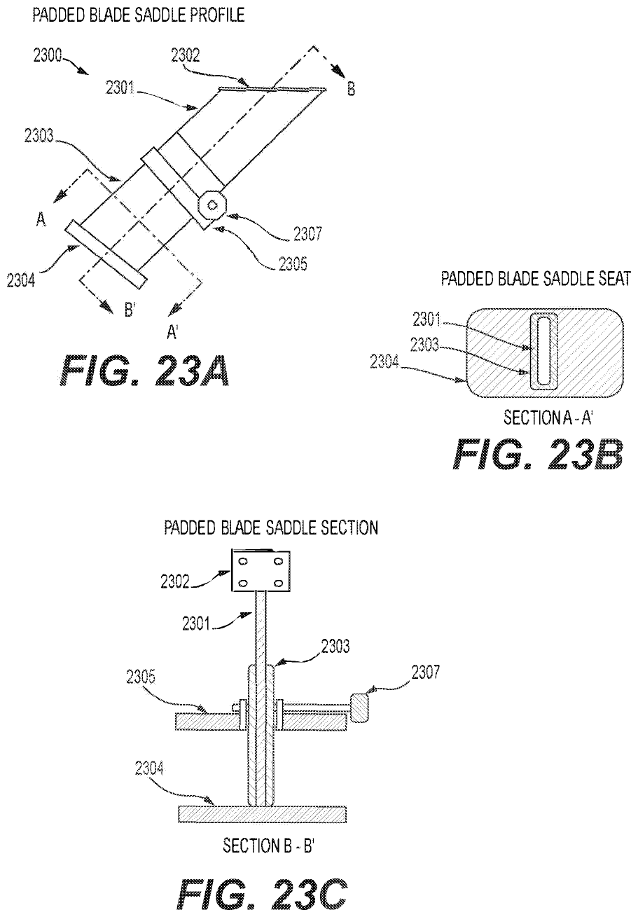

The solution disclosed in this application is a microgravity workstation that has two parts. The first part (FIG. 7A) is a specially designed downdraft table that attracts and adheres objects to its surface. The second part (FIGS. 23A-C) is a specially designed microgravity seat that allows astronauts seated around the table to immobilize their torso relative to the table. As described in this application, combining the two into a microgravity workstation (FIG. 20, FIG. 22A, and FIG. 22B) will allow astronauts to safely and easily perform a host of activities involving fine motor control hand movements, dealing with small parts, playing games, manipulating implements, cooking from scratch, serving and eating food and performing processes involving potential release of particulates. Up until this invention, all these activities have been impossible, nearly so, or unsafe on platforms like the ISS and future spacecraft having microgravity environments.

### Conventional Downdraft Table Technology:

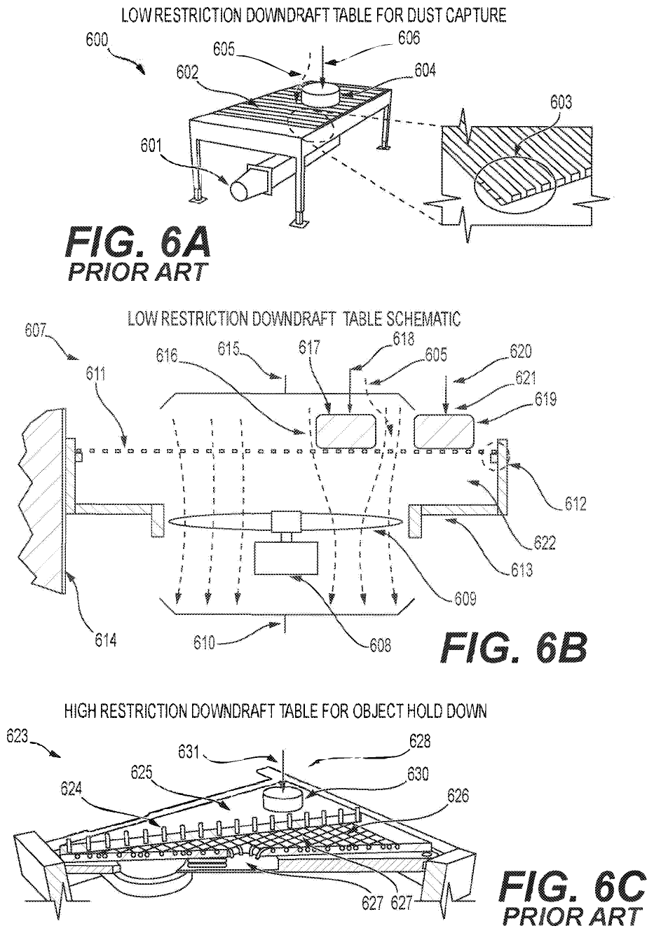

Conventional downdraft tables of various designs are commonly used for capturing chemical fumes and supporting sanding operations generating particulates inside a workshop. FIG. 6A shows a prior art downdraft table 600 made by Axminster tools for use in sanding operations. In this device a shop vacuum unit (not-shown) suctions air from port 601 which is drawn vertically down through the table top 602 that in this case is constructed of parallel slots 603 that allow air to pass freely through. When an object 604 to be sanded is placed on the table 600, conformal air currents 605 pass around the object 604, drawing off any sanding dust emitted into the air around it. This dust is subsequently filtered out of the stream by the shop vacuum (not-shown) connected to port 601. Frictional or air drag forces 606 resulting from the conformal air currents 605 acting on object 604 tend to slightly press object 604 harder against the table top 602 than by gravity alone. As will be shown later from experimental results, these additional downward forces are usually equivalent to less than 5% of the weight of a typical object.

FIG. 6B shows some of the elements of a low restriction downdraft table in an embodiment. In low-restriction downdraft table 607, a fan comprises a fan motor 608 that spins a fan blade 609 to draw air quantity 610 through expanded ferrous steel grate 611 positioned by ledge 612 at an inlet of a plenum chamber 613. Air is exhausted through an outlet of the plenum chamber 613 beneath the fan blade 609, as depicted in FIG. 6B. Plenum chamber 613 which comprises the body of downdraft table 607 is typically bolted to a bulkhead 614 of the habited environment it is part of, such as being attached to one of the inner walls of the ISS. As air flow 615 is drawn down through expanded metal grate 611, parts of the airflow 616 and 605 travel around the edges of block 617 placed on top of expanded metal grate 611. The friction of the airflow 616 and conformal air currents 605 around block 617 slightly pushes it against the top of grate 611 with force 618. Similarly, airflow 616 pass by block 619 and due to their air friction against its sides also causes a force 620 slightly pushing block 619 against grate 611. However, in the shown geometry of a fan blade 609 pulling air through low air restriction grate 611 it can be easily inferred that most of airflow 615 will pass through the center of the grate. Thus, the air forces 618 on block 617 will naturally be larger than the air forces 620 on block 619 that is positioned mostly to the side of air flow 615. Therefore, while the setup in low-restriction downdraft table 607 may assist with holding blocks to a table in microgravity, the holding force is highly variable depending on where the block is placed relative to the largest body of air flow. In aerodynamic theory, the airflow 616 and conformal air currents 605 could be said to be billowing on top of the objects 604, 617 and 619. This billowing may cause a higher pressure 621 on top of the object as in block 619 compared to beneath the object at point 622. While small, because the open grate 611 tends to equalize the pressure 621 and pressure 622, this pressure difference, in addition to surface friction, contributes slightly to the forces 606, 618 and 620 acting on the objects.

FIG. 6C shows a prior art high restriction downdraft table 623 of a design from a Make Magazine article entitled “ShopBot Desktop Universal Vacuum Hold-down System”. In this configuration air 624 is drawn through the open pores of a medium-density fiberboard (MDF) bleeder board 625 that had been shaved on both faces to expose the pores between the wood granules. Suction at port 627 pulls this air 624 through the bleeder board 625 and through cut channels in baseboard 626. The air flow 624 friction going through the bleeder board 625 is much higher than the friction of the air flow 615 going through the open grate 611. Therefore the pressure difference between the air channels of baseboard 626 measured at pressure 629 below the bleeder board is much lower due to the suction at port 627 that the ambient air pressure 628 above the bleeder board. When an object 630 with a substantially flat bottom is placed on top of bleeder board 625 it chokes off the flow 624 through the bleeder board causing the vacuum pressure 629 to act through the pores onto the bottom of object 630. The resulting pressure difference of ambient pressure 628 acting on the top of the object and vacuum pressure 629 acting on the bottom of the object 630 causes the downward force 631 to be relatively large compared to the forces in downdraft tables 607 and 600 for the same air flow. For this reason, high restriction downdraft table 623 is commonly used to hold down plywood to bleeder board work surfaces while it is being routed into shapes commonly used in building furniture. However, the high air restriction configuration 623 is poorly suited for holding down objects in microgravity because the rate of airflow 615 is so low as to affect only flat objects 630 directly touching its surface. The use of wood-based MDF fiberboard in spacecraft would also be impractical. The high restriction downdraft table 623 would also not be used because its surface could be loaded up with debris sucked and filtered from the surrounding air. If the suction was ever turned off, the MDF would release the debris that would then float in a microgravity induced airborne cloud back into the spacecraft cabin. For these reasons a particular inventive design of a downdraft table is required for use in microgravity space environments.

The Downdraft Table of this Invention:

The downdraft table of this invention is designed to pull airborne floating debris to its surface and hold larger objects in microgravity with features that ensure its safe and utilitarian use. The inventive downdraft table is shown in FIG. 7 in its most basic form and primarily differs from the previous downdraft tables of FIGS. 6 a, 6 b and 6 c in that it incorporates two fabric flow resistive layers into its top working surface.

The functions of these layers and other innovations in the downdraft table portion of this invention include the following:
Filtering overall cabin air drawn through the unit by using air filtration media as the air restriction media.
Drawing down crumbs and miscellaneous objects floating above the table.
Adhering objects to the table surface via air flowing around their edges.
Adhering objects to the table via static air pressure difference above and below the object.
Layering two layers of air restriction filter media such that the outer layer can be rolled up and discarded when it becomes soiled or layden with particles without breaking the pressure differential that holds them to the surface nor leaving the airflow unfiltered.
Ability to seal off the top surface by unrolling a self-adhering non-porous layer over the top filter layer such that blower power can be turned off, the airflow stopped, yet formerly captured particles remain captured.
Ability to remove the sealing layer by rolling back without losing adhesion of formally captured particles to the top air restriction filter layer.
Ability to use a high-vacuum hand vacuum to remove excess particles from any of the air restriction layers while the downdraft table is operating and continuing to capture particles on its surface.
A low air restriction ferrous base screen that allows objects and resistive films to be adhered to the downdraft table surface with magnets.
Vacuum blower features: Use of a large diameter axial ducted blower fan to provide a downdraft table vacuum without excessive noise or power drain. (Squirrel cage centrifugal fan may also be used)
Use of an additional air restrictive layer in the blower exit stream to dissipate the airflow over a large surface thus reducing its exit velocity that otherwise might cause harm by blowing things around in the cabin's microgravity environment.
The use of a cubby frame that magnetically attaches to the top of the downdraft table and serves to store and restrain multiple stacked objects from floating away.
The use of deployable side walls increases the effective height and strength of a table's downdraft zone.

These advantages will be described in detail in the balance of this detailed description.

FIG. 7 shows the microgravity workstation's fundamental downdraft table components. As in FIG. 6B, plenum chamber 613 comprises the body of downdraft table 700 that is bolted to an interior bulkhead 614 of a spacecraft that provides a microgravity environment. Items enumerated with like numerals are the same or similar and their description may not be repeated accordingly. Fan motor 608 rotates fan blade 609 to draw air 610 into the inlet of the plenum 613 which is refreshed by air currents 701 passing equally through every part of the downdraft table resistive layers 702 (see resistive layer detail in FIG. 7) resulting in an overall downward air velocity 703 entering the inlet of table 700. The velocity 703 is typically 0.5 meter/second towards the center of the table although it might be as small as 0.1 meter/second and as high as 1.5 meter/second. The velocity of air currents 701 are approximately the same as the overall air velocity 703 unless a substantial portion of the downdraft covering layers 702 is blocked by objects such as objects 710 and 711 in which case the air current 701 velocity may be higher than overall downward air velocity 703. Note that incoming air velocity 703 is actually a diffuse array of incoming velocity vectors as the downdraft table surface 702 draws air from the cabin environment. Toward the center of the table, the incoming air velocity 703 is substantially vertical and toward the edges of the table it angles in as air is pulled over the edge of the table. The downdraft table resistive layers 702 comprise the top of the downdraft table and it may be approximately 70 cm on a side with an area of approximately 0.5 square meters in a typical spacecraft installation.

Referring to the resistive layer detail of FIG. 7, air currents 701 pass downward through an outer resistive filter layer 704 then through an inner resistive filter layer 705, then through expanded metal grate 611. As the air currents 701 pass through the resistive filter layers 704 and 705, a pressure drop is created. This is analogous to the electrical voltage drop when electrical currents pass through electric resistors. Air 610 is then exhausted through the outlet of plenum 613 via the fan blade 609.

For the purpose of the following descriptions and calculations, pressure 706 represents deviation from standard environmental atmospheric pressure. Atmospheric pressure in a spacecraft may vary but is often set at 14.7 psia, which is the same as earth sea level. In the metric system is equivalent to 101,353 pascals where 1 pascal is equivalent to a pressure of 0.0102 grams/cm2. Pressure 706 is designated in this application as the local deviation from atmospheric pressure and since it clearly is positioned on the outside of the invention in local atmospheric pressure it is herein designated as 0 pascals for the purposes of calculations.

Again referring to the resistive layer detail of FIG. 7, as air currents 701 pass through the outer resistive filter 704 then through viscous friction the pressure is reduced to pressure 707. In embodiments, the resistive filter layers 704, 705 are both made from polyester filtration media cloth designated as Merv 13 effectiveness. The Merv designation refers to the average fineness of filtration where higher numbers indicate finer filtration. While the stated pressures in this disclosure refer to Merv 13 filter material, any porous material layer made from any construction with any Merv level can be used for resistive layers 704 and 705 depending on application-specific design requirements. Using the stated Merv 13 material, when air currents 701 collectively move at a velocity of 0.5 meters/second, then pressure 707 will be measured as −11 Pascals, which is often referred to as a pressure drop. As the air currents 701 further travel through the inner resistive layer 705 there will be an additional −11 Pascal pressure drop leading to pressure 708 being read out as −22 Pascals. Conversely, when air currents 701 pass through expanded metal open grate 611 there will be essentially zero resistance to air currents 701 and therefore pressure 709 is measured the same as pressure 708 at −22 Pascals. Accordingly, when air currents 701 pass through the specified stack of two resistive layers and one open grate 702, then the pressure inside the plenum body 613 of the downdraft table 700 is −22 Pascals across the entirety of the bottom side of resistive layers 702 inside plenum housing 613. Because the pressure 709 is constant across the entirety of the bottom of resistive layers 702, then everywhere the top side of resistive layers 702 is equal to the ambient pressure 706 of 0 Pascals then the air flow currents 701 will be of constant velocity and suction ability. Effectively, the resistive layers 702 make any part of the table 700's surface perform the same in suction ability, unlike the case in the low-restriction downdraft tables 600 and 607 wherein the amount of suction varies from center to edge.

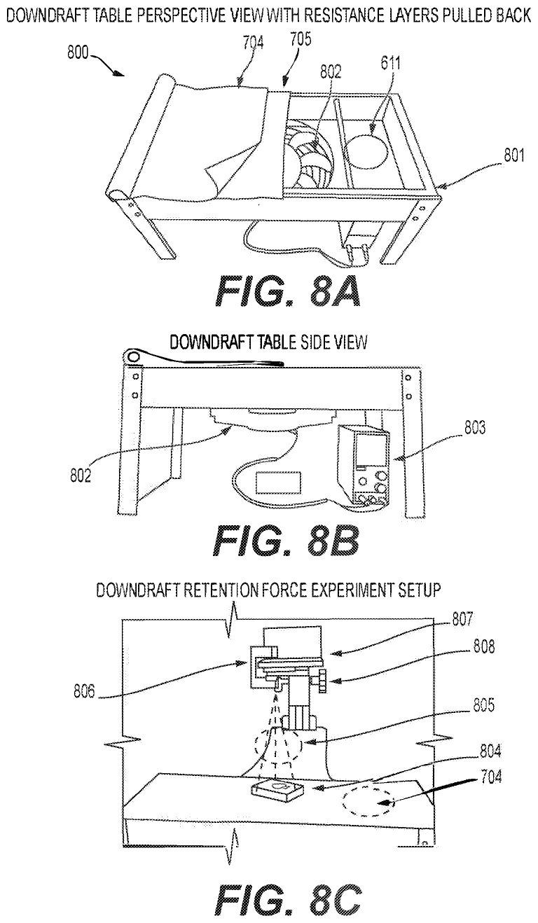

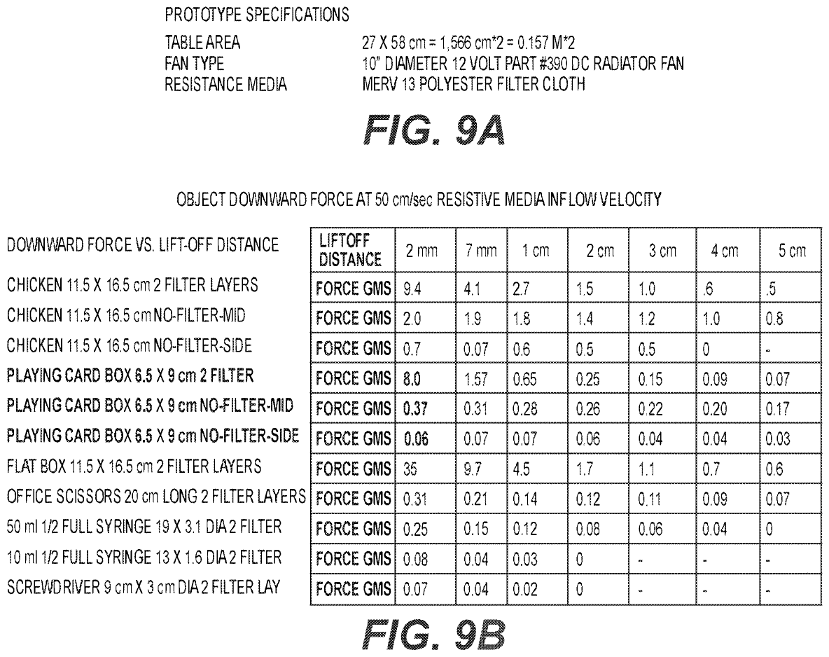

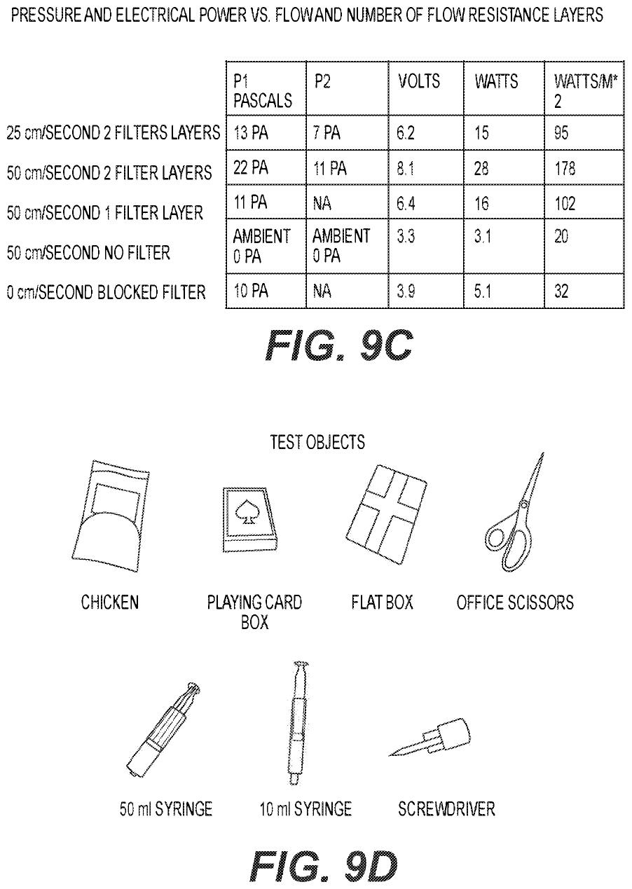

In FIG. 7, air-impermeable object 710 is shown spaced immediately on top of the air resistive stack 702. In this position air flow currents 701 are blocked off and have zero velocity below object 710. With no air currents 701 flowing through 702 there will be no resistive pressure drops or difference across 702 under object 710. Accordingly, if the pressure 709 in plenum 613 is −22 Pascals, then pressure 712 right under object 710 will also be −22 pascals. Since the pressure 706 above object 710 is 0 Pascals then the relative air pressure difference pushing object 710 down is 22 Pascals. To turn this into grams we multiply the bottom surface area of the object 710 times the Pascal pressure equivalent. For example, if object 710 is a box of playing cards, its dimensions are 6.5 cm by 9 cm creating a bottom surface area of 58.5 cm2. Accordingly, the force 713 pressing object 710 down would be 58.5 cm2×22 Pascals×0.0102 grams/cm2=13.1 grams. FIG. 8C shows an experimental apparatus that was used to measure this value and specifications for the table are listed in FIG. 9A. Results are shown in FIG. 9B in the line labeled “Playing card box 6.5×9 cm2 filter”. For technical reasons it is difficult to measure the surface attraction force of object 710 hanging from threads without pulling it slightly above the surface. Accordingly, at approximately 2 mm above the surface, the table in FIG. 9B shows the recorded attraction force as 8 grams which, while less than the 13.1 grams predicted, was within normal experimental error considering leakage air 716 was likely diminishing the vacuum. Further results showed the force 713 rapidly diminished as the box of cards was lifted above the surface yet still being meaningful in the role of returning a floating object to the surface. In FIG. 7 several factors can be seen in play as another exemplary object 711 is shown lifted further above the surface. First, the downward attractive force rapidly diminishes because of leakage air 716 under the object yet the conformal air currents 605 continue to press the object toward the surface.

Looking at the data in FIG. 9B it can be generally said that objects 710 with a flat bottom surface stick to the surface 702 with relatively high attachment forces while objects with irregular slight profiles like a pair of scissors have small attachment forces. However, the flow of air 701 at 50 cm/second was sufficient to move all objects toward the surface even when spaced 5 cm away. Accordingly, the invention has been experimentally shown to be useful in “keeping objects where they are put” which is a frequently underappreciated virtue of normal gravity in that it keeps our lives organized and familiar objects at hand. The microgravity workstation is configured to bring that convenience to microgravity environments as well.

FIG. 8A shows a perspective view of a downdraft table 800 with resistive layers 702 pulled back. The table's plenum chamber 801 is covered with low restriction grate 611 made from steel mesh and a top view of DC suction fan 802. Outer resistive layer 704 is pulled back to reveal inner resistive layer 705 which is pulled back to show low restriction grate 611. FIG. 8B shows a side view of downdraft table 800 and shows the variable voltage DC power supply 803 that is used to power the extraction fan 802 at different speeds. FIG. 8C shows the downdraft retention force experimental setup that was used to collect the data presented in FIG. 9B and FIG. 9C. FIG. 9D illustrates various objects tested for use with the downdraft table. An object 804 is suspended above the outer resistive surface 704 by a lightweight harness 805 made of thread to a “C” adaptor 806 that couples the tension on the harness 805 to the surface of sensitive electronic scale 807. In operation, with the DC fan 802 turned off and the object 804 lifted slightly above outer resistive layer 704, the electronic scale 807 is zeroed by pressing its “tare” button. In this zeroed state, the DC fan 802 is turned back on at a voltage that causes the velocity of air 701 through the resistive layers 702 to be 50 cm/second. Then the height adjustment knob 808 is used to position the object 804 at various levels above the resistive layer 702 that are listed in the table of FIG. 9B with an object downward force at 50 cm/sec resistance media inflow velocity. FIG. 9B also shows the downward force 715 according to different heights above the resistive surface 702.

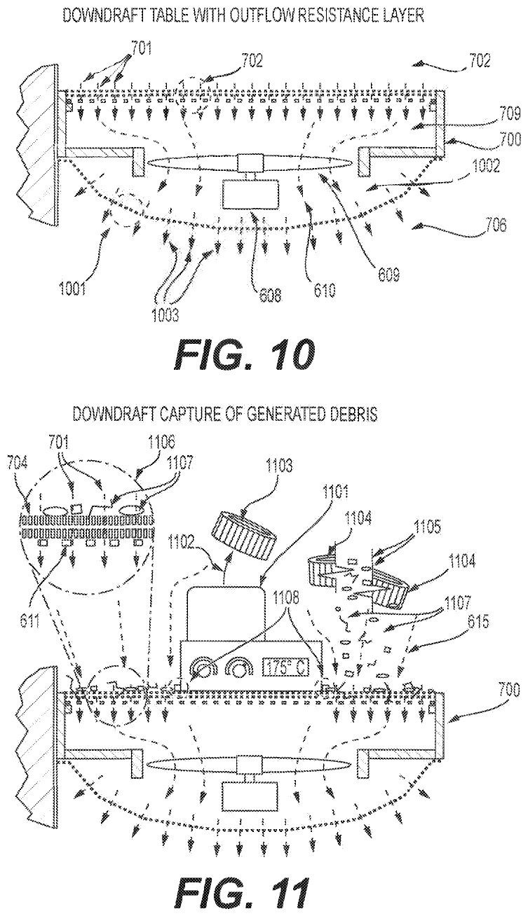

FIG. 10 shows a downdraft table 700 with outflow resistive layer 1001 around the outlet of plenum 613 that is made of filtration materials similar to resistive layers 704 and 705. In this embodiment, air flow 701 is drawn through resistive layers 702 by fan motor 608 driving fan blade 609 and pressing air quantity 610 through outflow resistive layer 1001, wherein the flow emerges as equal velocity air currents 1003. When exiting fan blade 609 without restriction, air quantity 610 can exist as a high velocity stream as shown by the parallel flow lines in FIG. 6B. However, as shown in FIG. 10, air quantity 610 can be forced to spread out as it presses against the inside of outflow resistive layer 1001, thus resulting in flow velocities of air streams 1003 to be equal across all of outflow resistive layer 1001, and of lower velocity than if air quantity 610 were unrestrained. This is important because aboard a spacecraft it is important to avoid high velocity airstreams when possible as they can spread materials throughout the spacecraft cabin volume. Accordingly, the use of the outflow resistive layer 1001 makes the downdraft table of this invention more “spacecraft friendly”. It should be noted that the air pressure in FIG. 10 changes from atmospheric pressure 706 to −22 pascals at pressure 709 assuming an air flow 701 velocity of 50 cm/second and a resistivity as resistive layers 702. And that pressure 1002 must be some positive value of Pascals to push air flow 610 through the resistive layer 1001 into the external environment of ambient pressure 706. If the total surface area of the outflow resistive layer 1001 is the same as the resistive layer 702 then given the same air flow 701 rate of 50 cm/second, pressure 1002 would be +11 Pascals and the air flow 1003 velocities would also be 50 cm/second. If however, the outflow resistive layer 1001 is constructed such that it billows out into a larger surface area than resistive layer 702, then the air flow 1003 velocities will be lower than 50 cm/second in proportion to the area ratio. This is important because by sizing the area of the resistive layer 1001, the air flow 1003 velocity may be adjusted to be suitable for any spacecraft or space habitat environment.

FIG. 11 shows a principle application of the invention which is to allow activities such as cooking, equipment service and mealtimes to be freely engaged in while keeping an orderly work surface and without the fear of spreading particulate debris 1105 inside a weightless cabin. Particulates in microgravity tend to spread in a cloud and can easily become an aspiration hazard affecting the safety of astronauts. In FIG. 11, downdraft table 700 is used to host a microgravity cooking device 1101 which is held to the surface of downdraft table 700 by a combination of surface suction from the pressure differential and magnets 1108 which interact with the ferrous steel grate 611. At the completion of a cooking process, food item 1103 is removed 1102 from microgravity cooking appliance 1101. Subsequently, the astronaut user of cooking device 1101 may wish to break apart the food item 1103 into two or more parts 1104 for consumption. In the process of breaking apart or consumption, food crumbs or debris 1105 are generated. Because of air flow 615, the food crumbs or debris 1105 are drawn down to the debris fouled resistive layers 1106 where the captured debris 1107 are pressed onto the outer resistive filter layer 704 by the movement of air currents 701.

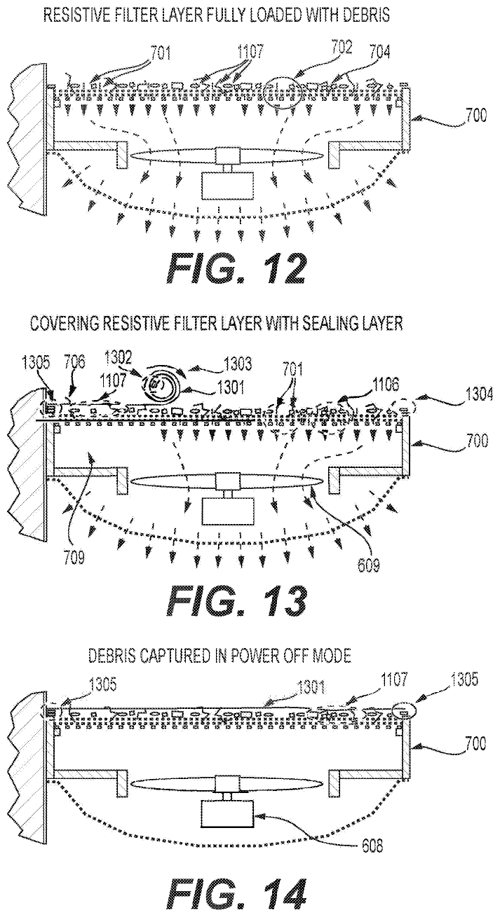

FIG. 12 shows the outer resistive filter layer 704 of filter layers 702 fully loaded with debris 1107 such that air currents 701 become blocked on parts of the outer resistive layer 704 of downdraft table 700. When outer resistive layer 704 loads up with excessive debris 1107 the air flows 701 can begin to get clogged and the outer resistive layer 704 can take on a soiled and unsanitary appearance.

FIG. 13 shows the unrolling 1303 of substantially air and debris impermeable layer 1301 in order to cover over debris 1107 loading the debris fouled resistive layers 1106. Impermeable layer 1301 may be constructed from transparent plastic film of about 0.25 mm in thickness and that is bordered with magnetic strips 1302. The top border of downdraft table 700 is also covered by magnetic strips 1304 on all four sides. As impermeable layer 1301 is unrolled, the magnetic strip 1302 on its border magnetically affixes itself to corresponding magnetic strips 1304 on table 700, such that the impermeable layer 1301 magnetically seals to the edges 1305 of table 700 thus capturing debris 1107. Air currents 701 keep the remaining debris 1107 in contact with table surface 702. As impermeable layer 1301 is unrolled 1303, the negative air pressure 709 compared to ambient pressure 706 keeps the impermeable layer in firm contact with debris loaded resistive layers 1106 while the fan blade 609 continues to draw air currents 701 through the debris fouled resistive layers 1106.

FIG. 14 shows impermeable layer 1301 fully unrolled and magnetically sealed to the edges 1305 of the downdraft table 700 thus fully containing debris 1107. Since magnetic attraction between strips 1302 and 1304 is keeping layer 1301 magnetically sealed at the edges 1305, then the fan motor 608 can be turned off. With a downdraft table 700 having a top surface 702 area of 0.5 square meter, the electrical power required to draw air currents 701 through it at 50 cm/second will be approximately 90 watts. Accordingly, by unrolling the magnetically sealed impermeable layer 1301 onto the top of downdraft table 700 and turning fan motor 608 off, then considerable power can be saved on the spacecraft without incurring any danger of the trapped debris 1107 re-entering the cabin atmosphere.

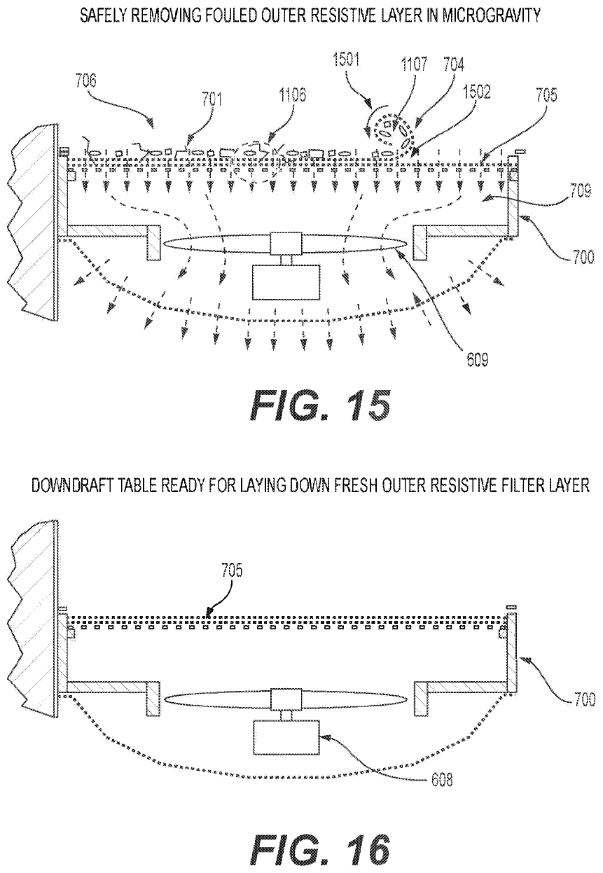

FIG. 15 shows how debris fouled resistive layers 1106 can be safely removed in microgravity. With downdraft table 700's fan blade 609 still drawing air flow 701 through debris fouled resistive layers 1106, the outer resistive layer 704 is rolled up 1501 entrapping debris 1107 in the center of the roll. As outer resistive layer 704 is rolled, inner resistive layer 705 is exposed reducing the pressure difference between the plenum pressure 709 and ambient pressure 706, however sufficient air flow 701 will remain to keep debris 1107 from floating off the surface of the debris fouled resistive layers 1106. Air currents 1502 will help keep the debris 1107 in the roll of outer resistive layer 704. When outer resistive layer 704 is fully rolled up then it can be discarded and a clean new outer resistive layer 704 unrolled in its place.

FIG. 16 shows the downdraft table without the outer resistive layer and ready for a new installation of outer resistive layer 704 to be rolled out. In this state only the clean inner resistive layer 705 is exposed so fan motor 608 can be turned off without fear of debris floating away.

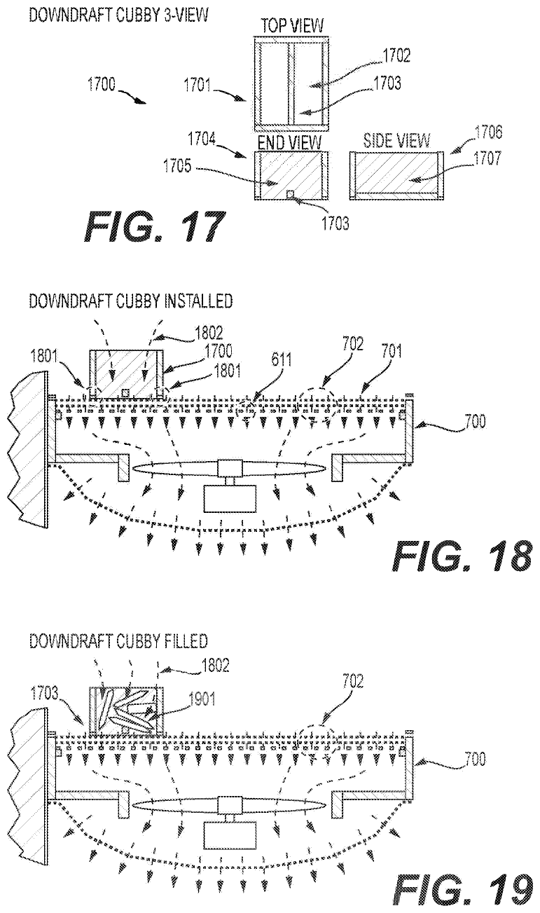

FIG. 17 shows a downdraft cubby 1700 from three different views. The top view 1701 shows that the cubby 1700 is an open bottomed 1702 box bisected by a single blocking beam 1703. The cubby's end view 1704 shows a substantially transparent plastic end wall 1705. The cubby' side view 1706 shows a substantially transparent plastic side wall 1707. In an embodiment, the cubby inside dimensions are roughly 20 cm long, 25 cm long and 15 cm high in order to hold an assortment of small objects 1901 such that they can be viewed in place.

FIG. 18 shows the downdraft cubby 1700 installed onto the resistive layers 702 of the downdraft table 700 by using magnets 1801 on the bottom edge of the cubby that interact with the ferrous steel grate 611. Air currents 701 flow equally across the downdraft table 700 resistive layer's surface 702 and draw air through the open bottom of the cubby shown as air currents 1802.

FIG. 19 shows the downdraft cubby 1700 containing objects 1901 that might include cooking supplies or desk accessories or items for an experiment, for example. Air currents 1802 flow down around the objects 1901 and through air friction and aerodynamic forces keep objects 1901 from floating out of the cubby 1700. Blocking beam 1703 prevents flat objects 1901 from being drawn flat against the resistive layer surface 702 blocking off the ability of the air currents 701 to translate into incoming air currents 1802 that act upon the upper objects 1901. The advantage of the cubby 1700 is that it can hold a stack of objects 1901 rather than just the object 1901 closest to the resistive layer 702. This is because the aerodynamic holding forces of air currents 1802 act mostly on the top object in the stack 1901 which helps to hold down objects 1901 below it.

FIG. 20 shows the microgravity downdraft workstation 2000 comprising the padded blade microgravity saddle 2300 and its attachment flange 2302 to the microgravity downdraft table 700. The downdraft table 700 is then attached to the interior bulkhead 614 of a habitat, a parabolic flight aircraft or a spacecraft in which the invention is to be used. In operation, downdraft table 700 may host equipment attached to its resistive layer surface 702, such as a cooking appliance 1101 attached to the resistive layer surface 702 with magnets 1108. A broad variety of objects may be attached to surface 702 either with magnets or through the vacuum effect of its surface. For example, equipment under repair, food packets, a laptop or elements of a game (like playing cards). Air currents 701 occurring regularly across surface 702 are drawn through that surface by fan motor 608 driving suction fan blade 609 which thereafter forces the air downwards as air currents 1003. Air currents 701 induce downward airflow 615 which serve to draw floating debris down onto the resistive layer surface 702 where the debris are held in place.

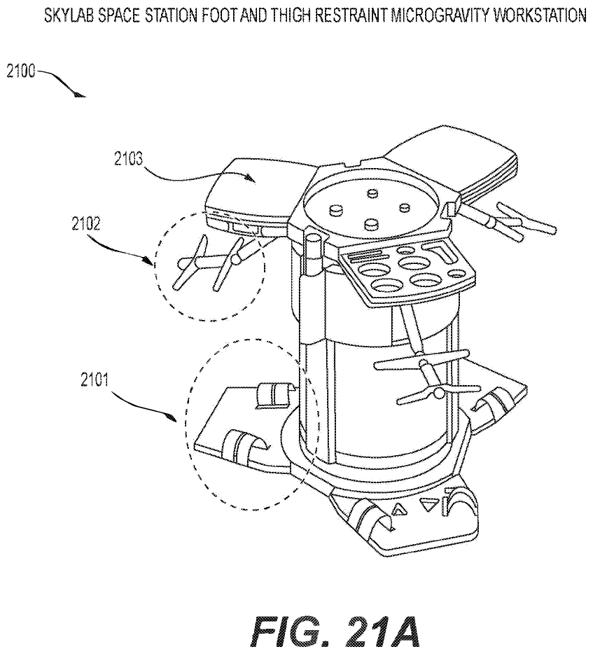

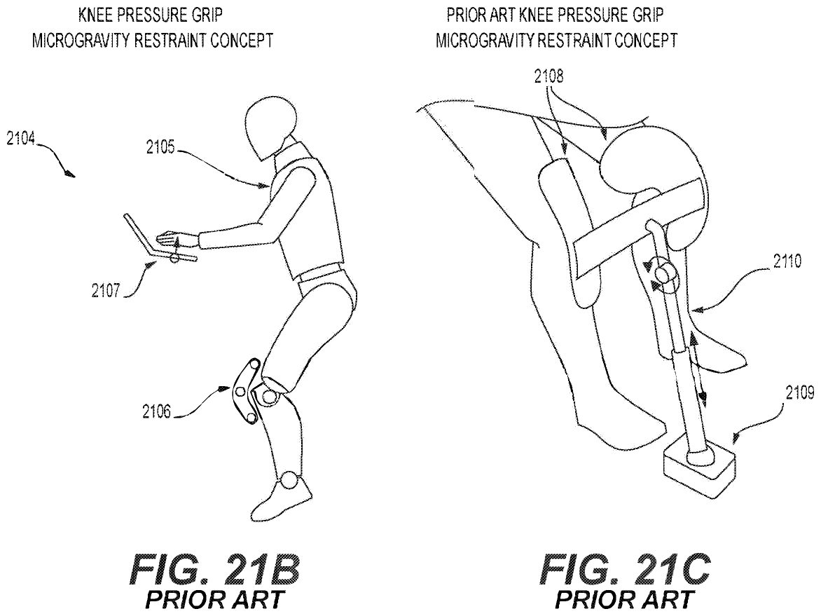

FIG. 21A shows a prior art workstation 2100 for microgravity that was used on the Skylab space station which was occupied for 24 weeks between 1973 and 1974. This design had the astronauts place their forefeet into two floor loops 2101 after straddling the thigh clamp 2102. The workstation worktop 2103 had provision for 3 astronauts to face each other but no known provision but straps and Velcro to hold objects to the work surface. The combination of foot loop and thigh clamp also appears difficult to get into and restrictive to upper body movement.

FIG. 21B is a side view showing a prior art microgravity restraint concept 2104 intended to enable a workstation. FIG. 21C is a perspective view of the prior art microgravity restraint concept 2104. FIGS. 21B and 21C are best viewed together with the following description. The astronaut 2105 was expected to pinch their knees together over a molded assembly shown in 2106 and 2108 that had a high friction surface. The molded assembly was to be connected to the spacecraft through mount 2109 and adjusted in position using an extendable rod 2110. There are no known test results for this device; however the example of its use is the astronaut 2105 working on a laptop 2107. The problems seen with this device are that the astronaut needs to continuously apply closing force between their knees to remain stable and not float away. The other problem appears to be, considering that only the knees are stabilized, of how to provide enough reaction torque to quickly move your upper body around in attending to desktop tasks.

FIG. 22A shows an exemplary workstation 2200 for microgravity environments having a padded blade saddle 2202. The astronaut 2201 mounts the padded blade saddle 2202 attached to their microgravity downdraft table 700 enabling the astronaut to have both hands free and the body stability to enable fine motor control of the hands for working on equipment like the food appliance 2203 while potentially reaching for ingredients in the workstation cubby 2205. The workstation is attached to its environment in this case by the bottom flange 2206. It should be noted that the padded blade saddle 2202 could be used independently of the downdraft workstation 2200. For example, the padded blade saddle 2202 could be mounted in front of a control panel or other object needing manipulation and hand dexterity so that the control panel operator is able to use two hands on the controls without being strapped into a seat, as is common in spacecraft.

FIG. 22B shows another view of the workstation 2200 with astronaut 2201 sitting in one padded blade saddle working on an object 2203. On the other side of the microgravity downdraft table 700 one can see the blade portion 2207, the top thigh restraint 2209 and the seat plate 2208 of the padded blade saddle 2202.

FIG. 23A shows the padded blade saddle in profile. The blade may be made of any strong material and is attached to the downdraft table 900 through interface flange 2302. In embodiments, the padded blade 2303 is covered with a soft high friction material like foam rubber or a carpet like material about 5 to 10 cm wide tapered between the thigh position and about 20 cm deep along the axis of the thigh; seat plate 2304 is about 25 cm wide and 20 cm deep; upper thigh clamp 2305 is about 25 cm wide and 25 cm deep and incorporates an adjustment mechanism 2307 which allows the upper thigh clamp 2305 to slide along the length of the padded blade 2303 so as to put the desired amount of thigh pinching pressure for comfort and stability. FIG. 23B shows the seat plate 2304 in profile using section A-A. FIG. 23C shows the relative widths of the seat plate 2304 and upper thigh clamp 2305 in section B-B.

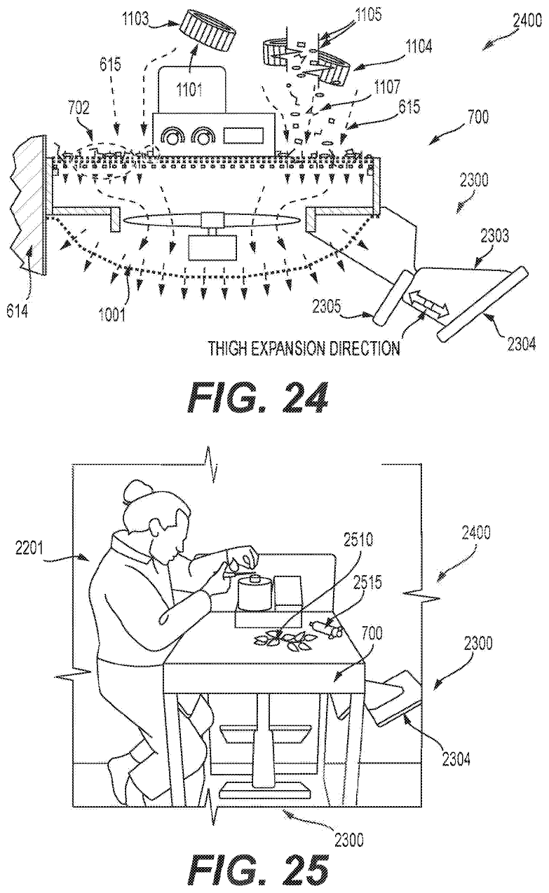

FIG. 24 shows a microgravity environment workstation 2400 having downdraft table 700 with outflow resistive layer 1001 and padded blade microgravity saddle 2300 mounted to the downdraft table 700. FIG. 24 shows a side view of a padded blade microgravity saddle 2300 with a direction of thigh expansion indicated between seat plate 2304 and upper thigh clamp 2305.

FIG. 25 is a perspective view of microgravity environment workstation 2400 having a plurality of padded blade microgravity saddles 2300. FIG. 25 shows how materials 2510 and equipment 2515 are held down to a top side of downdraft table 700 while being used by the astronaut 2201 who is seated in one of the padded blade microgravity saddles 2300.

In operation, the astronaut 2201 mounts the padded blade saddle 2300, and after adjusting the thigh pinching pressure for comfort, thereafter controls the stabilizing force of the padded blade saddle by modulating the closing force between their thighs. According to the Poisson's Ratio principle, as an elastic material is compressed in one direction it tends to widen along an axis perpendicular to the compressive movement. Similarly, as the astronaut uses their inner thigh muscles to pinch the padded blade 2303 between their thighs, the elastic nature of their thigh muscles causes an expansion on an axis parallel to the blade further compressing the thigh between seat plate 2304 and thigh plate 2305. Additionally, the muscles that power the pinching motion knot up and increase in diameter further increasing the compressive forces of the astronaut's thigh between thigh plate 2305 and seat plate 2304. As a result, when the astronaut wishes to increase their stability or immobilization relative to the workstation 2000 (or the spacecraft in general through mounting bulkhead 614), they simply press their thighs more firmly together in an intuitive manner. In doing so, their thigh closing muscle expansion and Poisson's Ratio lead to more surface force against the upper thigh plate 2305 and the inner surface of the seat plate 2304. Additionally, the friction material covering a surface of padded blade 2303 increases friction against the user's thighs. The increased surface friction in combination with the increased contact area between the astronaut 2201 and saddle 2300 stabilizes the astronaut 2201 from linear displacement in all three X, Y, and Z linear axes. The increase in friction also stabilizes the astronaut's thighs in the rotational axes (i.e., roll, pitch and yaw). The resultant six degree-of-freedom stability enables the astronaut 2201 to stabilize and brace their upper body by reacting against their thighs using their hip and torso muscles. By stabilizing their upper body, the astronaut may intuitively stabilize their hand and head motion against reactive forces, thereby increasing eye-hand coordination, two handed dexterity, and an ability to exert force or torque on external objects without needing to brace oneself with another hand. The increased stability improves the use of hand tools, operation of instruments (e.g., a microscope requiring correct placement of the eyes over the microscope's controls), or control of a needle and sutures during a medical procedure, or any number of other activities requiring dexterity and hand-eye coordination that we take for granted when sitting in a chair or standing firmly in Earth's gravity.

There is a positional stability problem in microgravity in that no microgravity seating solutions are currently used on the ISS. Instead, when astronauts work on experiments or other activities needing them to stay in one place, they put their shoes under restraint straps mounted on the surfaces designated as floors throughout the ISS. The advantage of the padded blade microgravity saddle disclosed herein is that it is configured to easily mount in microgravity and provide torso and upper body stability and control with very little thigh closing pressure. This improved stability will enable the astronaut freedom to use both hands because they don't have to hold onto anything for stability. It will also provide more manual fine motor control and upper body stability because the body is anchoring itself to the spacecraft through their thighs rather than knee or forefoot restraints alone, yet still providing upper body freedom to move around. Additionally, if the astronauts relaxes their legs and stops clamping they will still be unlikely to float away because of the adjustable clamping action of the upper thigh clamp.

A problem in microgravity environments is that many individual things are needed for daily life, as in life on Earth, whether they be toiletries, parts and accessories, or ingredients and spices for food. Whereas on Earth we set them on a shelf or table, in microgravity they simply float away (e.g., see FIG. 1). More specifically, it is difficult to place an item in microgravity with the zero velocity required to make it stay in one place. For example, if elastic packages of any substance are bunched and placed within a 3D volume, the packages simply spring apart from one another. Dry powders and granules often acquire the same electrostatic charge causing them to rapidly flow out of open containers and spread apart from each other, thus filling an open space.

Consequently, on orbital platforms like the International Space Station (ISS), powders and granules are prohibited and larger items are either kept in bags or individually held to surfaces with fasteners (e.g., Velcro). The problem with objects floating around the habitat is that an astronaut must constantly look through bags to get the required object or resort to individually fastening all the objects that might be needed to any available surface. In photos of the ISS interior, every surface appears covered with fastened objects. The resulting clutter is not optimal for mental health and calm, nor is there enough room on the surfaces to hold everything one would need. As processes in microgravity, like science experimentation or cooking from scratch ingredients, become more complex, a system and method to conveniently and efficiently hold multitudes of objects while permitting easy selective access to each individual object is needed.

Another problem in microgravity environments is providing access to sets of objects. Typically on the ISS, objects are stored in stiff cloth bags. An astronaut retrieves an object by holding onto a bag and controlling its contents with one hand, while rustling around to find the desired object with the other hand. When a specific set of independently selected items is desired, obtaining those items becomes awkward. After pulling one item from the bag, it must be let loose in space, grabbed with the teeth or slipped under the fingers of the opposing hand holding onto the bag. The more objects needed to be withdrawn as a set, the more untenable keeping track of them all becomes. A process like cooking might need to have ten items between various food spices, ingredients, cooking implements, cleaning wipes and serving utensils. Acquisition and control of ad hoc selections must be improved to routinely implement tasks in microgravity that require multiple items.

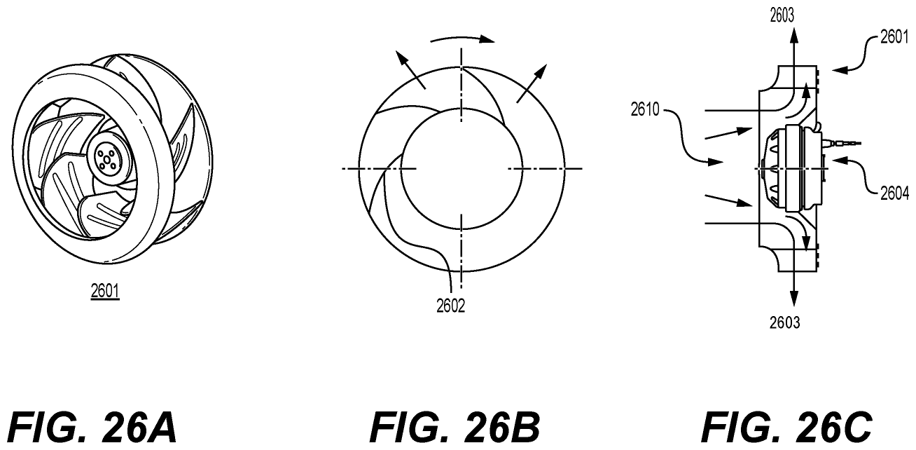

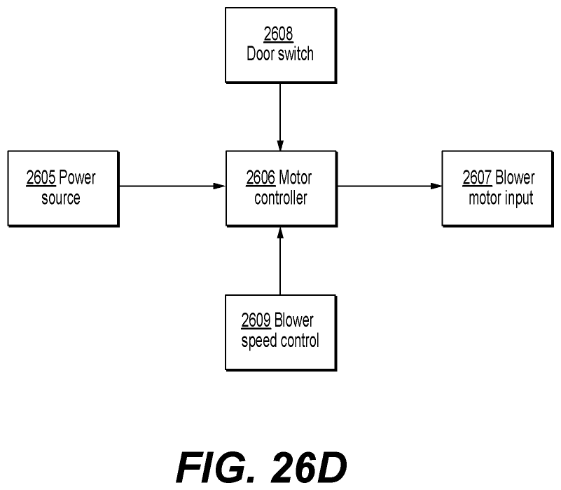

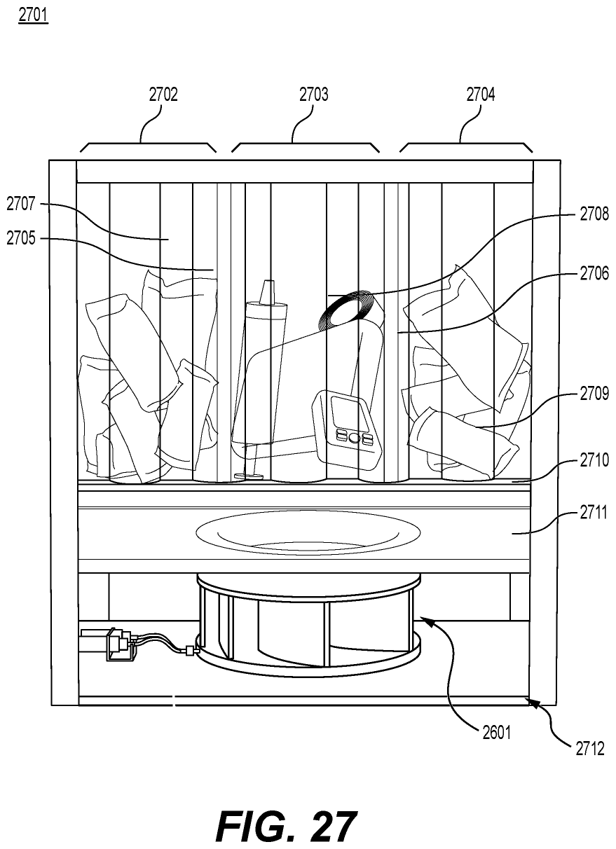

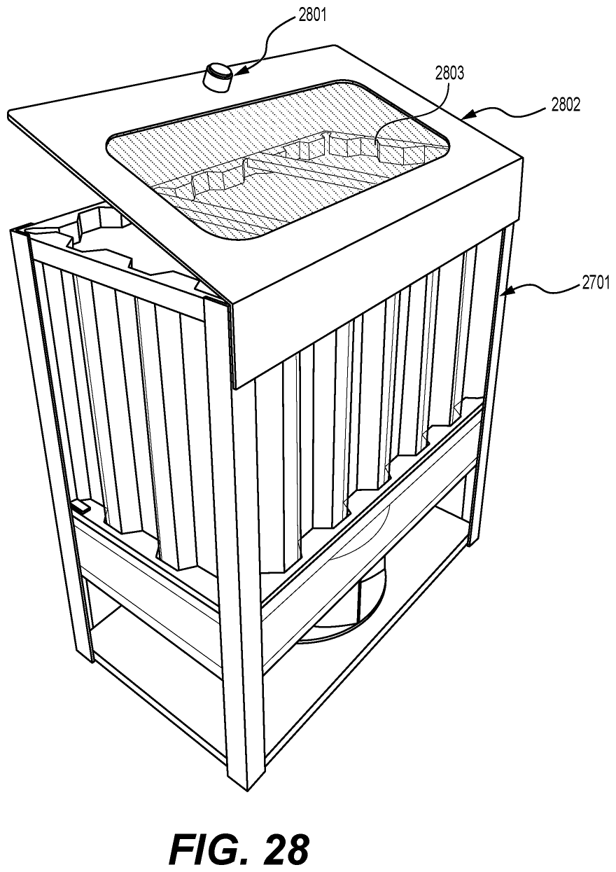

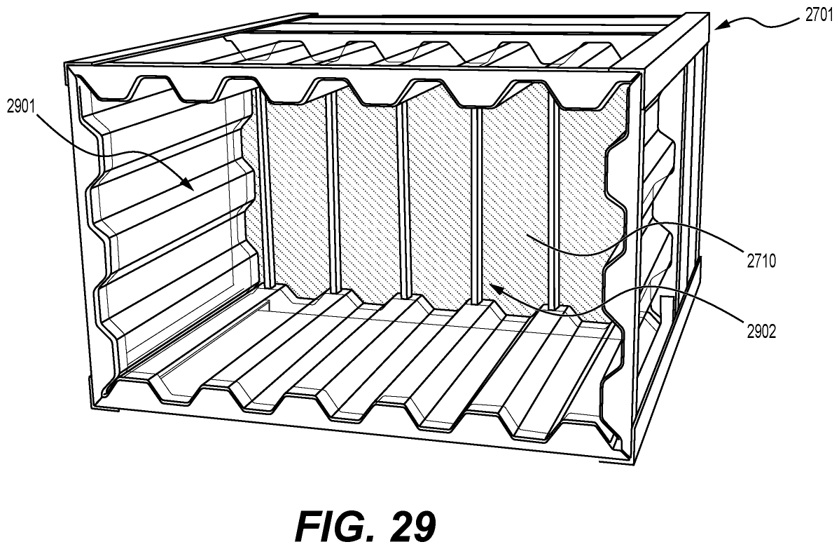

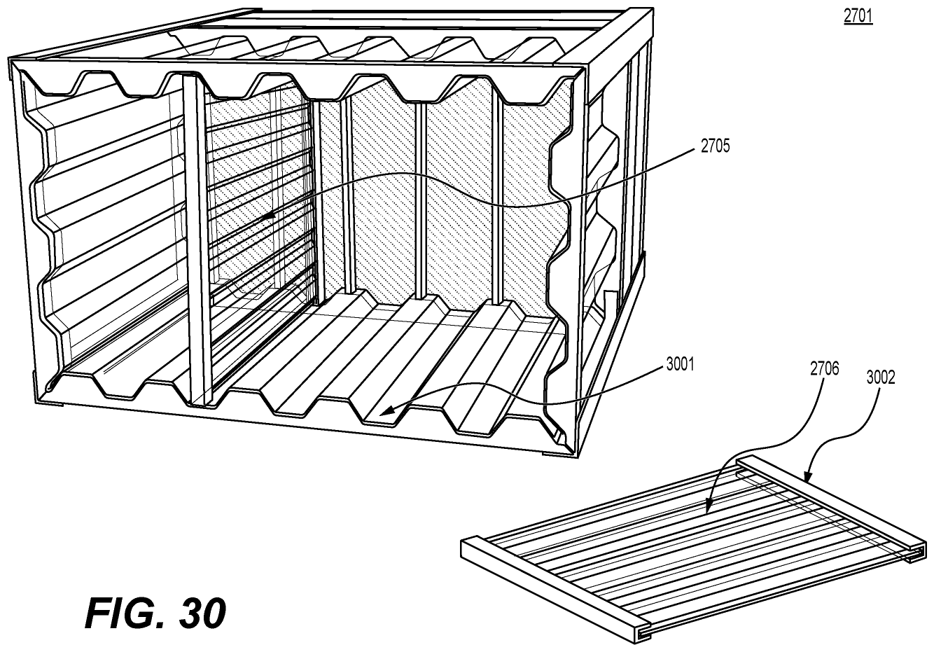

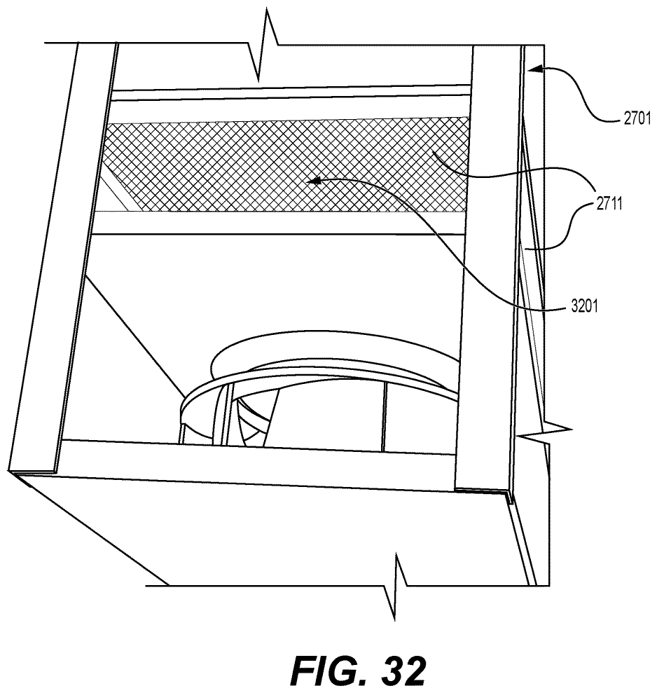

FIGS. 26A, 26B, 26C, 27, 28, 29, 30, and 31 illustrate another embodiment of a cubby 1700 for use without a downdraft table. FIG. 26A-26C show an impeller for use with the cubby, FIG. 26D is a block diagram of a controller for controlling the impeller. FIGS. 28-31 are additional view of cubby 2701. FIG. 32 is a partial perspective view of a filter for use with the cubby of FIG. 27. FIGS. 26A-32 are best viewed together in the following description.

FIG. 27 shows a side view of pneumatic storage cubby 2701, which mitigates the problem of floating objects in microgravity environments by sucking a flow of air into a box through a filter cloth or grill in the bottom of the cubby. The flow of air draws objects placed into the mouth of the cubby towards the bottom of the cubby where they rest against the grill or filter cloth that the air flow is being sucked through. Cubby 2701 is similar to the downdraft cubby 1700.

In one embodiment, cubby 2701 uses a backwards curved impeller blower as shown in FIG. 26A. The fan motor 608 and fan blade 609 of downdraft cubby 1700 are replaced by a backward curved impeller 2601 with a motor 2604 integrated into central hole 2610. Backward curved blowers draw air in through their central hole 2610 and eject it radially through the impeller 2602. The air movement principle of operation shown by arrows 2603 in FIG. 26C shows how a small number of impeller blades move the air. A strong advantage of the backwards curved blower 2601 is that this technology can suck air through the resistance filter assembly 2710 both more efficiently and with lower generated noise. Having reduced noise in any piece of equipment is extremely important in space habitats because so much equipment is simultaneously making noise that it can create a stressful and unhealthy living environment. Backwards curved impeller blower 2601 is easily obtained from companies such as ebm-papst or the Orion Fans model ODB22599 series with an air flow of 835 CFM (cubic feet per minute) and a noise level of 67 dBA.

As a further improvement over the previous cubby illustrated in FIGS. 17, 18 and 19, cubby 2701 is self-contained with its own blower unit and may be installed in an experiment locker or attached to a habitation bulkhead. For example, cubby 2701 may be configured as a standard Vast Space haven-1 or ISS standard experiment bay. In the parlance these are: 1. (On the International Space Station (ISS), EXPRESS Racks and ISPRs (International Standard Payload Racks) that serve as experiment lockers) and 2. On the VAST HAVEN-1 space station called: (Middeck Locker Equivalent Payload Slots).

FIG. 26D shows an exemplary controller configured for controlling the backward curved blower 2601. A power source 2605 is operatively coupled via a motor controller 2606 to a blower motor input 2607. When a door switch 2608 is activated, a command signal is sent to the motor controller 2606 to initiate the backward curved blower 2601 when the storage cubby door 2802 (see FIG. 28) is opened. This ensures the contents of the cubby are retained by air flow whenever the door 2802 is open, whereas otherwise they would begin to float out into the cabin in microgravity. Blower control knob and latch 2801 is configured such that when the storage cubby door 2802 is unlatched, the switch 2608 automatically starts the blower. In embodiments, the same knob 2801 is configured as the speed control for the blower. At higher speeds, objects are more firmly drawn into the cubby 2701, whereas at lower speeds, the noise levels are reduced. The storage cubby screen vent 2803 enables the blower 2601 to begin running without pulling the cubby door 2802 shut. Screen vent 2803 also allows the contents of the cubby to be seen from the top of cubby 2601.

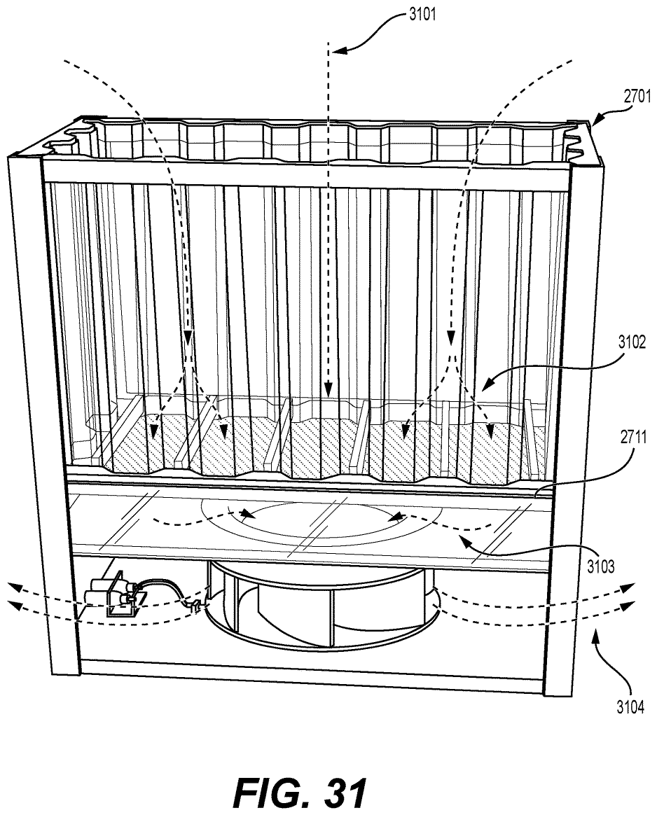

In addition to the above features, the bottom and walls of the improved cubby 2701 may include corrugated features 2901 to maintain cubby airflow around contents even when those contents lean against the walls. FIG. 31 illustrates the general airflow 3101 into the cubby 2701 and then flows 3102 through the resistance filter assembly at the bottom and then is drawn 3103 through the blower plenum 2711 into the central hole 2610 of backward curved blower 2600. The air then ejects from the blower impeller 2601 as stream 3104.

The corrugations in the cubby walls 2901 are aligned with the flow of air. The corrugations allow air to continue being drawn into the cubby and around the edges of objects that might be leaning against a wall thus continuing to pull a stack of objects on top of each other towards the bottom of the cubby 2701. To prevent objects drawn to the bottom of cubby 2701 from choking off the air flow, bottom baffles 2902 are spaced above the resistance filter to prevent objects from lying flat on resistance filter 2710 and the space above the filter allows air to be able to be sucked laterally under objects above it.

In embodiments, a cubby is able to be segmented into separate, non-mixing, storage areas. For example, a spice cabinet or desk drawer might have movable dividing walls or shelves. When a cubby has one dividing wall 2705, making two sub-cubbies, then it is easy to go through a multitude of objects, transferring them from one cubby to being stabilized in another until the object desired is found. However, often a selection of objects may be required and then it is preferred to have two dividing walls, a first divider 2705 and a second divider 2706, thus creating three sub-cubbies. In this arrangement, the astronaut may transfer objects from first sub-cubby 2702 to second sub-cubby 2703 until the desired set objects are one-by-one found and assembled into a complete set of desired items in for example, third sub-cubby 2704. The 2901 transparent corrugated walls allow the astronaut to see the items in the stack as they are being rustled through. An improved cubby can have any rectangular or cylindrical form as long as air is getting sucked from one end to pull items towards the opposite end.

The dividers 2705, 2706 are inserted into 3001 corrugation slots in the walls of the improved cubby 2701. The cubby dividers may themselves be made with corrugations to prevent choking of the air flow and are fixed in a cubby divider frame 3002 that makes them easy to insert and move around.

FIG. 27 shows relatively large and diverse stacks of objects in the improved cubby 2701. For example, many food ingredients 2707 are stored in first sub-cubby 2702. A stack of other food ingredients 2709 are stored in third sub-cubby 2704. Which ingredients are in which cubby can be sorted by using second sub-cubby 2703 as temporary storage. Second sub-cubby 2703 is shown filled with 2708 science instruments and supplies to illustrate the general utility of a sub-cubby system. Blower 2601 is supported by mounting plate 2712.

The resistance filter assembly 2710 comprises a cloth filter layer stretched over support grill 3201, with the filter cloth on its top surface facing the inside of the storage cubby. When power is applied to the blower motor input 2601, the blower 2606 sucks air from the blower plenum 2711 which pulls a vacuum on the bottom of the resistance filter assembly 2710. The air pressure drop across the filter assembly 2710 is larger than the expected pressure drop from all the objects that can be stacked in any of the sub-cubbies. Therefore, the flow of air between any of the three sub-cubbies is relatively equal regardless of the number of objects they contain.

The filter cloth layer can be cleaned with a powerful hand vacuum from the inside of the cubby while the blower 2601 is running in case stored contents become spilled inside the cubby. The blower plenum 2711 optionally has a transparent wall to allow the astronauts to verify that no material has slipped or drained through the filter assembly.

The manned spaceflight requirements for downdraft table 700 are dominated by strength required to overcome launch loading, fire safety of the components, ability to fulfill a useful mission and quietness of its operation. Secondary, but also important requirements include minimum weight and power requirements, human factors design, attractiveness, reliability and repairability.

Using 3D manufacturing technology provides high strength, attractiveness, good human factors design options and the ability to make smooth and specifically engineered air flow passages. These along with stiff structure, enable low noise operation required for space crew comfort. 3D manufacturing technology also reduces the part count which increases the reliability and repairability as long as the structure itself is not damaged.

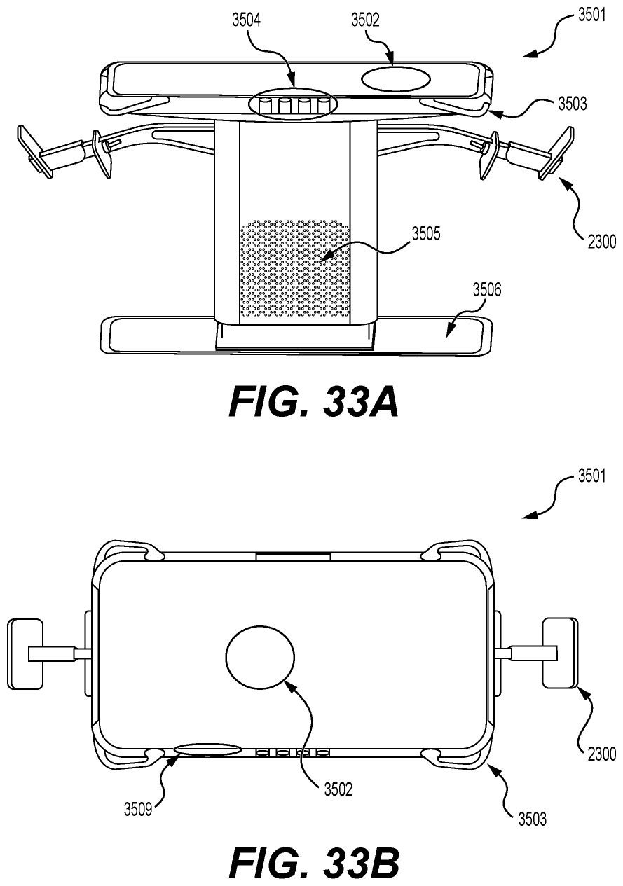

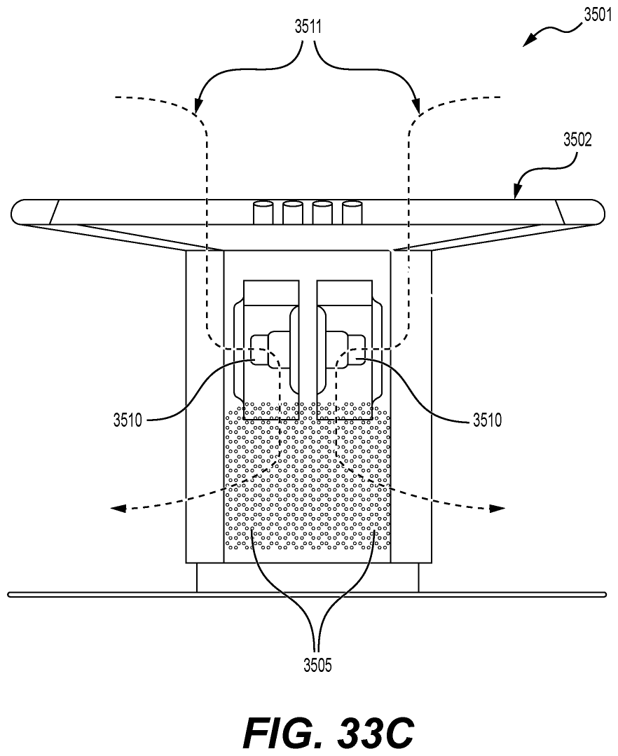

FIGS. 33A-33C are best viewed together in the following description.

FIG. 33A shows downdraft workstation 3501 in a form that may be manufactured using 3D technologies. In embodiments, the outer observable surfaces, interior airflow channels and part mounting flanges may be SLS (Selective Laser Sintering) 3D printed with materials such as Windform SP which is a carbon fiber polyamide composite that has flight proven experience aboard the SpaceX Crew Dragon spacecraft. The resistive filter layer 3502 may be made of a single layer of Nomex fireproof fabric. The durability and fine weave of the Nomex fabrics means it can be sufficiently cleaned with a hand vacuum and therefore will be unlikely to release particulates into the crew cabin when replaced. The padded blade stability saddles 2300 are similar to those shown in FIG. 24. The hand grips 3503 are 3D manufactured into the overall structure. The purpose of hand grips 3503 is to help an astronaut position and torque themselves into stability saddles 2300. The blower 3504 controls achieve a similar downdraft workstation speed control function for the backwards curved blowers 3510 that Blower speed control 2609 achieves for cubby 2701 using blower controller 2606. The blower outlet vent 3505 surrounds the base of downdraft workstation 3501 and releases the air pulled by the blowers through the resistance filter table covering.

FIG. 33B shows a top view of downdraft workstation 3501. Around the periphery of single-layer resistance filter 3502, sealing groove channel 3509 is positioned. This channel is of a generic design to receive a hollow rubber bead with rubber flange that is sewn to the edges of single layer resistance surface fabric 3502. FIG. 33C shows two counter-rotating backwards curved blowers 3510 that pull air through single-layer resistance filter surface 3502 and exhaust it through blower outlet vents 3505. The generalized path 3511 of air currents shows the general path of air flow through resistance filter surface 3502 into the center of counter-rotating backwards curved blowers 3510 and out the 3505 blower outlet vents. The purpose of having two counter-rotating blowers is to cancel their individual gyroscopic effects that can affect the stability of a space station's attitude control system. This is called a “reactionless” system. However, when being reactionless is not important to the space station then the air movement function of this system works equally well with just a single backwards curved blower. Additionally other air movement blower technologies can be used including the single 609 fan blade driven by the 608 fan motor or other styles of air blowers such as counter-rotating axial fans.

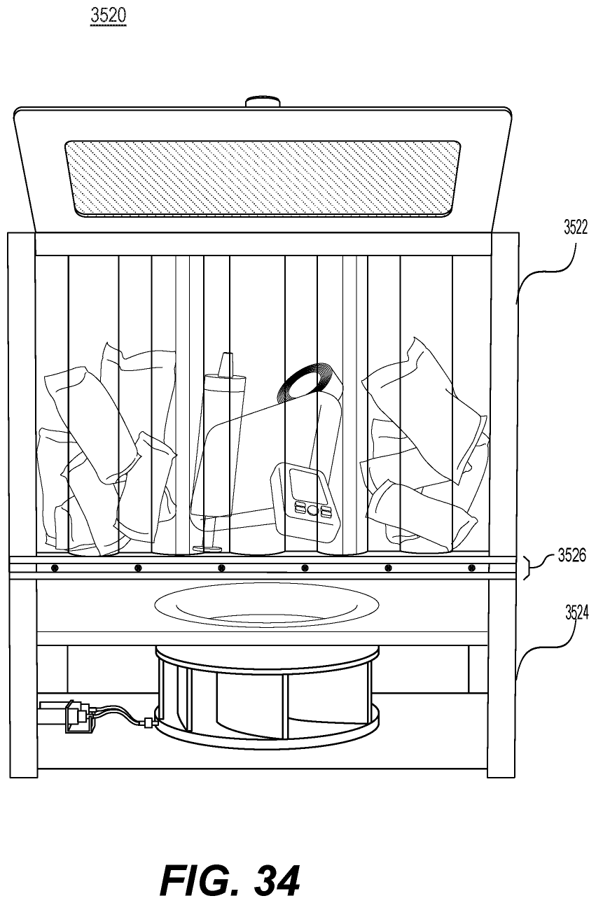

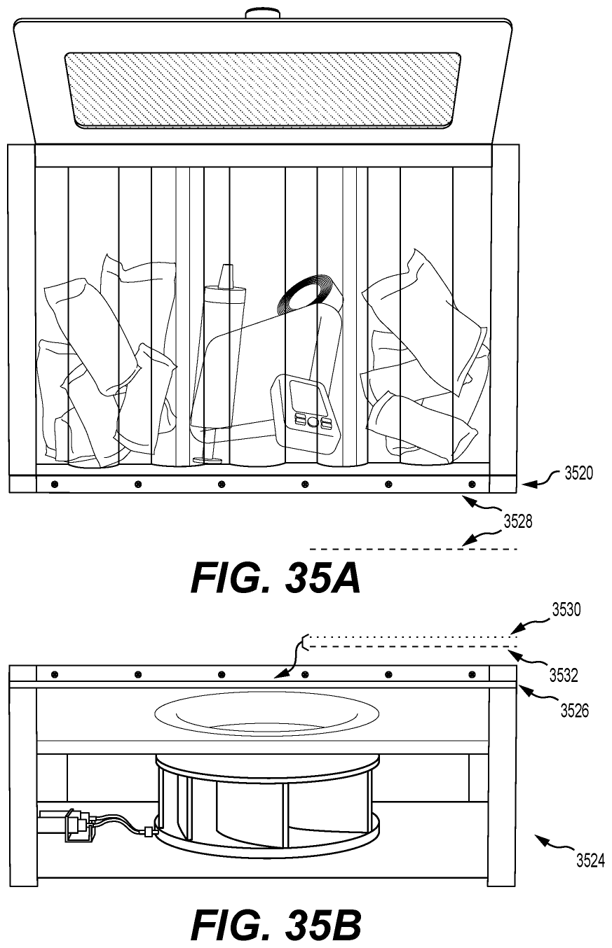

FIG. 34 is a side view of another embodiment of the cubby of FIG. 27, in embodiments. FIGS. 35A-35B are side views of the cubby of FIG. 34 and an independent power unit, in embodiments.

In embodiments, cubby 3520 includes cubby solo 3522 attached to the cubby independent power unit 3524 by detachable interface 3526 which can be attached or detached by the astronaut at will. In the same way that Downdraft Cubby 1700 can be placed upon Downdraft table 700, cubby solo 3520 may be placed on the downdraft table 3501. Additionally, cubby solo 3520 may be attached to cubby independent power unit 3524. In this way, the astronaut can choose to use several cubby solo 3520 units on a single downdraft table 3501 or downdraft table 700. Interface level 3528 comes together and mates with interface level 3530 and resistance filter support grill 3532 on the input face of independent power unit 3524.

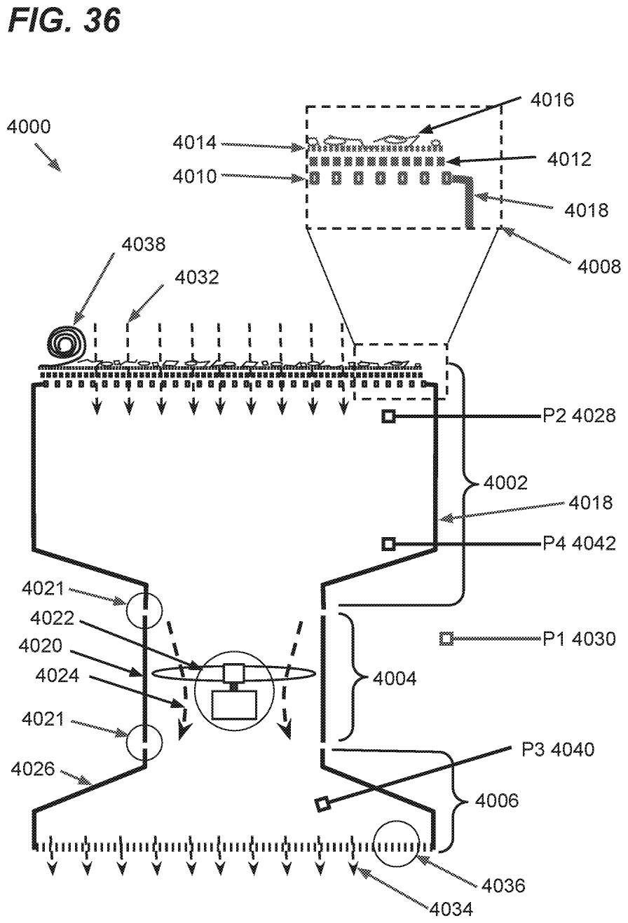

FIGS. 36-45 show another embodiment of a downdraft workstation

Downdraft workstation 4000 provides enhanced filtration and capture of finer ambient particles that may be present in a space habitat, particularly on the surface of the Moon or Mars. It also provides modular construction that allows it to be reconfigured with plenum extensions as a distributed module workstation 4100, enabling it to adapt to the confines of space habitats. As with downdraft workstation 700, worksurface filtration layers can be switched out while the ducted fan module 4004 is powered on, preventing particles from contaminating the habitat during filter maintenance. The utility of downdraft workstation 700 is driven by its relatively high 1 meter/second downdraft velocity, plus its resistance filter stack's surface suction that holds items down, plus the stack's relatively smooth outer working surface that allows coarse particulates to be easily removed with a hand vacuum. However, resistance filter stack materials suitable for these high airflow rates are not simultaneously able to filter the finest particulates. Particulate fines will increasingly be found both in low-gravity Lunar exploration as well as the increasing need for dealing with fine particulates in scientific and industrial processes aboard orbiting and transiting spacecraft in microgravity conditions.

Downdraft workstation 4000 incorporates a second filtration stage downstream of the resistance filter worksurface that both filters out the finest particulate and tightly secures them during power-off in an innovative self-sealing fines filter.

Handling dusty objects or hazardous powdered materials inside sealed habitats presents a serious contamination risk. In lunar and Mars habitats, geologic specimens, repaired equipment, and EVA suits carried indoors introduce regolith, a mechanically produced mixture of jagged particles ranging from millimeters down to nanometers. These particulate fines retain permanent sharp edges because the Moon has no wind or water erosion. Respirable lunar regolith fine particles below 10 μm, and particularly the nanophase iron-bearing agglutinitic glass fraction below 100 nm, are toxic to human lung tissue and damage sensitive equipment. The release of these particulate fines in microgravity can be particularly dangerous for astronaut habitats because the released particles never settle. Brownian motion and electrostatic effects distribute them uniformly throughout a volume, and in the process they will flow from a high-density particle region to a low-density particle region through any unsealed gap between the volumes. Accordingly, the improved downdraft workstation works to both filter these particles from the downdraft workstation outflow as well as securely contain the captured particulate fines from passively diffusing back into the environment during workstation powerdown. The improved downdraft workstation achieves this by incorporating an innovative self-sealing fines filter.

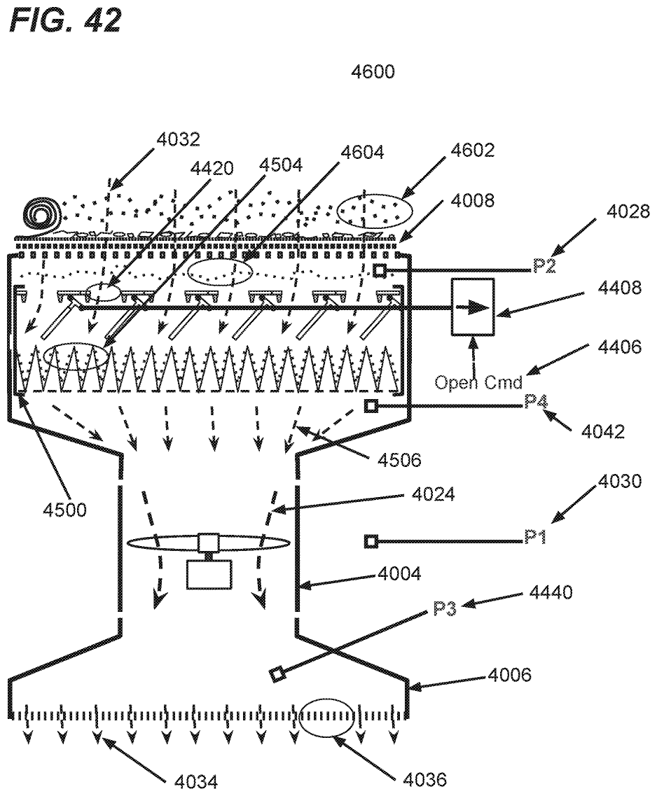

Downdraft workstation 700 addressed containment through a single or double resistive filter stack at nominally 1 m/s face velocity. This was sufficient to generate holding suction but too fast for effective ultrafine particle capture. Fibrous filter efficiency at very small particle sizes (0.1-0.3 μm) improves substantially at filter media pass-through velocities below 5 cm/s. Downdraft workstation 4600 of FIG. 42 uses a filtration approach that decouples these two functions. In the resistance filter stack, fire and off gassing-safe, woven E-glass or Aremid fabric still maintains the 1 m/s downdraft velocity and suction that physically restrains objects and prevents particle liftoff.

An alternative to woven E-glass or aramid fabric for the resistance filter stack working surface is a porous sintered metal sheet, preferably five-layer vacuum-sintered 316L stainless steel mesh with a nominal filtration rating of 10-20 μm. This construction is unconditionally compliant with NASA-STD-6001B with no flammability testing required, presents a rigid, smooth, abrasion-resistant metallic working surface that is impervious to puncture and mechanical damage from tools or hardware, and is cleanable in place by backflushing or ultrasonic methods without removal. Unlike woven fabric, the sintered metal layer is a permanent structural element rather than a consumable, eliminating the roll-and-replace maintenance requirement while providing coarse pre-filtration of particles above approximately 10-20 μm to protect the downstream pleated ePTFE fine filter. The pressure drop of a five-layer sintered 316L mesh at 1 m/s face velocity and 10-20 μm nominal rating is comparable to or lower than woven E-glass cloth at equivalent open area, and the all-metal construction contributes structural rigidity to the working surface module independent of any frame or substrate.

Downdraft workstation 4000 optionally adds a downstream pleated ePTFE membrane fines filter, with approximately 20× greater media area than the resistance filter stack, enabling the particle transit velocity through the finer media to be 20× slower, at approximately 5 cm/s. This provides EN1822 H14 filtration efficiency of ≥99.995% at the most penetrating particle size across the full lunar regolith hazard spectrum.

For simplicity of illustration, the pleated membrane fines filter design has been referenced throughout this description. However, the following fines filter design is preferred for the highest performance: While a pleat factor of approximately 20× is achievable with bead-separated mini-pleat construction at 100 mm filter depth, the preferred embodiment employs a pleat factor of approximately 32× achieved through a 150 mm deep filter body using corrugated aluminum separators between each pleat. In this configuration, the corrugated aluminum separator—with a corrugation amplitude matched to the pleat pitch of approximately 9.4 mm—runs the full 150 mm depth of each pleat channel, physically maintaining uniform channel geometry under operating differential pressure and preventing the pleat pinching that would occur with bead-type separators at this depth-to-pitch aspect ratio of approximately 16:1. At 32× pleat factor and 1 m/s housing face velocity, the media face velocity is reduced to approximately 3.1 cm/s, yielding a total filter pressure drop of approximately 71 Pa—meaningfully below the 112 Pa of the 20× configuration—while simultaneously improving filtration performance to EN1822 H14 equivalent efficiency of approximately 99.9975% at the most penetrating particle size of 0.15 μm. The corrugated aluminum separator construction is unconditionally compliant with NASA-STD-6001B flammability requirements, contains no organic materials, and is verified by commercial deep-body HEPA filter products at this geometry, including the Camfil CMX11 series at 610×610×150 mm nominal dimensions, achieving a documented media area of 12 m² within a 0.372 m² face area.

Additionally, electrostatic-based filters or filter enhancers may be effective against very small particles but may not be as suitable for space applications due to their use of non-fire-safe polymers.

The improved downdraft workstation additionally separates the assembly into three independently positionable modules: the working surface module, the ducted fan module, and the outflow diffuser module. This modular architecture serves three functions in a space habitat context. In the first function, it accommodates the constrained, irregular geometry of space habitat interiors by allowing each module to be routed and mounted independently, rather than requiring a single contiguous installation volume. Second, it reduces operator noise exposure by allowing the ducted fan, the primary acoustic source, to be located farther from the work position. Third, it enables deliberate management of cabin air circulation by decoupling the outflow diffuser location from the working surface inlet, allowing filtered exhaust air to be directed toward habitat inlets or away from crew rest areas independent of workstation placement.

The improved downdraft workstation shown in FIGS. 36-45 does not depict the pelvic stability seats. The pelvic stability seating remains a valuable part of any low- or micro-gravity workstation, and in practice will often be incorporated into downdraft workstation 4000.

FIG. 36 shows an improved downdraft workstation 4000 comprising a downdraft worksurface module 4002, a ducted fan module 4004, and an outflow diffuser module 4006. The downdraft worksurface module comprises a worksurface plenum 4018 connected to a ducted fan plenum 4020 via plenum fastening means 4021 on its air-outflow face, and covered with a support grill 4010 on its air-inflow face. The ducted fan module 4004 contains the fan 4022, which creates fan airflow 4024 in the direction shown, exiting into the outflow diffuser module 4006. The outflow diffuser plenum 4026 is fastened to the ducted fan plenum 4020 using plenum fastening means 4021. The plenums of the three modules form the primary structure that holds the subcomponents together and fastens the improved downdraft workstation 4000 to the interior of the space habitat. The plenums may be made of machined and welded aluminum, or, preferably, by 3D printing, which provides smooth airflow channels and the mounting provisions for all components. A preferred 3D printing technology is selective laser sintering (SLS) of Windform SP polyamide, which is currently in use on the Crew Dragon spacecraft for all three module plenums. With this 3D printing technology, the fastening means 4021 would preferably be tongue-in-groove mated flanges held together with locking screws.

While SLS-printed Windform SP polyamide may be used for the workstation plenums, several alternative additive manufacturing technologies and materials have demonstrated acceptability for manned spacecraft interior components and are suitable for workstation elements that do not contact the filtration airstream directly. Stratasys FDM-printed Ultem 9085 a polyetherimide thermoplastic with flight heritage on ISS, Antares resupply vehicles, and the Orion spacecraft is an established alternative for structural brackets and housings, having been certified and flown on spacecraft since 2013. PEEK and PEKK high-performance polymers, considered by Astrobotic for their lunar lander, offer superior thermal and chemical resistance and are printable via high-temperature FDM systems. Stratasys Antero 800NA, a PEEK-based material with electrostatic dissipative functionality, has been used on the Orion docking hatch door and is particularly suitable for workstation surfaces where lunar dust electrostatic charge accumulation is a concern. All candidate materials must be evaluated against NASA-STD-6001B for flammability and against NASA outgassing requirements (total mass loss <1.0%, collected volatile condensable materials <0.1%) prior to use in a pressurized habitat environment.

Air currents from the fan airflow 4024 press against the outflow diffuser fabric 4036 with approximately 5 to 10 pascals of air pressure, evenly distributing the diffuser airflow 4034 across the outflow diffuser fabric 4036, which is preferably made from a fireproof fabric like Nomex. The surface area of the outflow diffuser fabric 4036 is preferably larger than the area of the input resistance filter stack 4008 so that the exit velocity of air currents from the diffuser airflow 4034 is less than the nominal inlet velocity of downdraft air currents 4032. Reducing the air current exit velocity helps prevent blowing ambient cabin materials in microgravity. The shape of the outflow diffuser fabric 4036 is unconstrained and could just as likely be flat as a billowed bag filling an unused space in the habitat.

Resistance filter stack 4008 forms the working surface of the improved downdraft workstation 4000. When fan 4022 is running, it reduces the pressure detected by P2 resistance filter stack pressure sensor 4028 in worksurface plenum 4018 below the ambient pressure measured by P1 ambient pressure sensor 4030. This pressure differential across resistance filter stack 4008 causes downdraft air currents 4032 to flow down through the smooth worksurface filter 4014, the compliant resistance filter 4012, and into the worksurface plenum 4018 of the downdraft worksurface module 4002. When the improved downdraft workstation 4000 is operated in microgravity, larger debris 4016 from experimental work or daily living are filtered from the downdraft air currents 4032 and stick to the smooth worksurface filter 4014. From here, this debris 4016 may be vacuumed up with a portable hand vacuum to keep the worksurface clean. Finer debris 4016 are drawn into, and captured preferentially within the weave or fiber matrix of smooth worksurface filter 4014. When the smooth worksurface filter 4014 becomes excessively soiled, it can be rolled up while the ducted fan module 4004 is operating, then discarded and replaced with a clean outer worksurface. An impermeable layer 4038, made preferably of a tight fabric weave or plastic film, can be unrolled over the outer smooth worksurface filter 4014 while the ducted fan module 4004 is powered on, then fastened to the top edge of worksurface plenum 4018 using a string of magnetic strips or preferably a sealing zipper, allowing the improved downdraft workstation 4000 to be powered down with no loss of debris 4016 trapped on its surface or residing inside the pores of the resistance filter stack 4008.

The base of the resistance filter stack 4008 is the support grill 4010 that is bonded or otherwise attached to the entrance opening of the worksurface plenum 4018. Support grill 4010 supports the flexible compliant resistance filter 4012 layer, and on top of it, the flexible smooth worksurface filter 4014 layer, which, without the support grill 4010 would both be pulled down into the worksurface plenum 4018 by the vacuum generated by the ducted fan module 4004. In embodiments, the support grill 4010 needs to be mostly open and unrestrictive to downdraft air currents 4032, and be stiff and strong enough to support an astronaut's workday activities, which might include setting equipment on or leaning on the worksurface. An expanded and flattened metal mesh sheet is suitable for a support grill 4010. For lighter weight, the support grill 4010 can be a 3D-printed honeycomb structure about 18 mm thick, with roughly 5 mm hexagonal pores separated by wall thicknesses of about 0.6 mm, and SLS-printed from space-habitat-safe material such as Windform SP polyamide.

One role of the “compliant” in the compliant resistance filter 4012 is to bridge across the surface roughness of the support grill 4010, while allowing the smooth worksurface filter 4014 to provide a smooth and cleanable work surface. The airflow resistance, filtration, and absorbance specification of each layer would be designed to meet the requirements of the tasks most often performed on the surface. The roles of the smooth worksurface filter 4014 are to: resist wear and tear, absorb liquid spills, prevent most particles from moving through it, and be considered expendable and easy to routinely replace. In a typical application, the smooth worksurface filter 4014 would provide filtration equivalent to the MERV 13 standard. At a nominal downdraft air current 4032 rate of 1 meter/second, the smooth worksurface filter 4014 would present a pressure drop of no more than 120 pascals, and preferably no more than 60 pascals. A second role of the compliant resistance filter 4012 is to present enough airflow resistance as to cause the smooth worksurface filter 4014 to continue to adhere to its surface even when portions of smooth worksurface filter 4014 are being rolled up in preparation for its disposal and replacement. At a nominal downdraft air current 4032 of 1 meter/second, compliant resistance filter 4012 should present a pressure drop of approximately 20 to 60 pascals. The filtration specification for compliant resistance filter 4012 should be approximately MERV 11.

P1 ambient pressure sensor 4030 is used to measure the ambient atmosphere pressure, which may be lower in space habitats on the order of 8 to 10 psi. P2 resistance filter stack pressure sensor 4028 measures the pressure in the plenum under the resistance filter stack 4008 so that, in concert with knowing P1 ambient pressure sensor 4030, the pressure difference across the resistance filter stack 4008 can be determined. P3 diffuser plenum pressure sensor 4040, in concert with P1 ambient pressure sensor 4030, enables the determination of the pressure drop across the outflow diffuser fabric 4036. Fines filter exit pressure sensor P4 4042 helps determine the pressure difference across the self-sealing fines filter 4400 when installed in the improved downdraft workstation 4000.

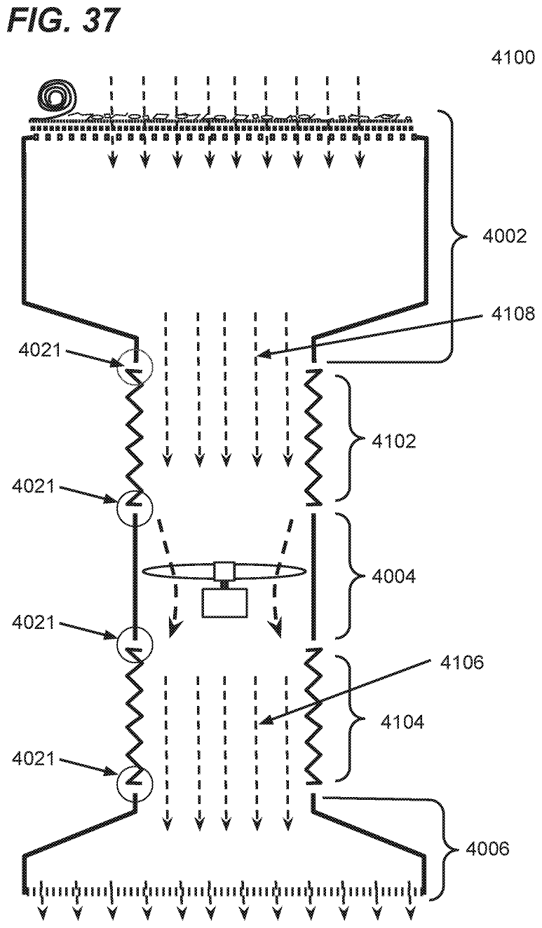

FIG. 37 shows the distributed module workstation 4100. It may be useful to separate the downdraft worksurface module 4002 from the ducted fan module 4004 for two primary reasons. First, the ducted fan module 4004 may produce excessive noise, making extended work sessions at the downdraft worksurface module 4002 difficult. Second, the preferred mounting of the downdraft worksurface module 4002 might be in a cramped area like the airlock of a Lunar habitat, where the ducted fan module 4004 will have to find a place it fits. Also, the downdraft worksurface module 4002 might provide a second purpose as a large vacuum head to help remove lunar dust from a spacesuit. In this case, the preferred mounting in the habitat's airlock might be vertical. To provide for this flexibility in location and orientation, worksurface extension ducting 4102 can be installed between downdraft worksurface module 4002 and ducted fan module 4004 using the same plenum fastening means 4021 between components to contain the worksurface airflow 4108. The worksurface extension ducting 4102 can be made of rigid materials like aluminum or from a flexible hose made from fireproof materials like Nomex with a clothes-drier-like spiral wire to prevent the partial vacuum in the worksurface plenum 4018 from collapsing it. For a specific length and worksurface area, the diameter of a hose can be calculated to provide only a nominal 15 pascals of resistance. For example, if the worksurface of the downdraft worksurface module 4002 were 0.5 square meters, the downdraft air currents 4032 were a nominal 1 meter/second, and the worksurface extension ducting 4102 were 2 meters long, then its diameter would need to be approximately 25 cm.

It may also be advantageous to move the outflow diffuser module 4006 farther from the ducted fan module 4004. For example, to find a better space for its volume or to control the overall circulation of air in the habitat. Outflow extension ducting 4104 channels fan module outflow 4106 to a remotely located outflow diffuser module 4006. Plenum fastening means 4021 connects the three components together. For a 2-meter run, the outflow extension ducting 4104 would be approximately 25 cm in diameter, but could be a simple fireproof fabric sleeve without spiral reinforcement, since the fan module outflow 4106 would put it under slight pressure.

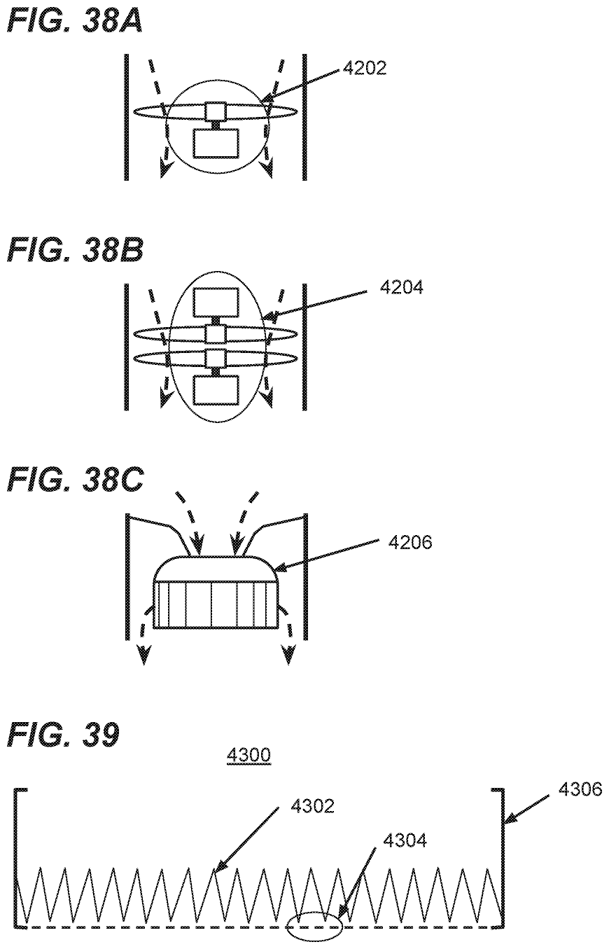

Ducted fan module 4004 can use several different fan technologies depending on the overall design requirements of an improved downdraft workstation 4000. FIG. 38A shows a ducted tube-axial fan 4202 that is commonly available in a high-speed, high-blade-count configuration of a style commonly found in modern low-noise leaf blowers. FIG. 38B shows a ducted tube-axial counter-rotating fan 4204 that is commonly found in industrial applications where compact size and high working pressure is required. FIG. 38C shows a ducted centrifugal fan 4206, of which one type is the backward angled centrifugal fan 2601, which is the preferred configuration to use in the ducted fan module 4004 because of its low noise, high working pressure, and high efficiency characteristics.

In embodiments, downdraft workstation 4000 may be used inside habitats on the lunar surface. The particles found in the regolith are jagged and can be dangerous to human health. However, the resistance filter stack 4008 is limited by its flat filter media configuration in the combination of desired passage, ability of downdraft air currents 4032 at velocity and fine particle filtering capabilities. Filters of the desired fineness necessarily have small pores, and the physics of capture requires that they pass through the media at relatively low velocity. This combination of factors cannot be found in a single flat layer of filter material and instead requires large areas of filter material to be pleated, or otherwise folded into a compact volume that can fit into a frame of similar dimensional surface area as the smooth worksurface filter 4014, thereby integrating into the same overall plenum. FIG. 39 shows a fire-safe fines filter 4300 consisting of pleated filter media 4302 supported by media support grill 4304 and housed in fines filter frame 4306.

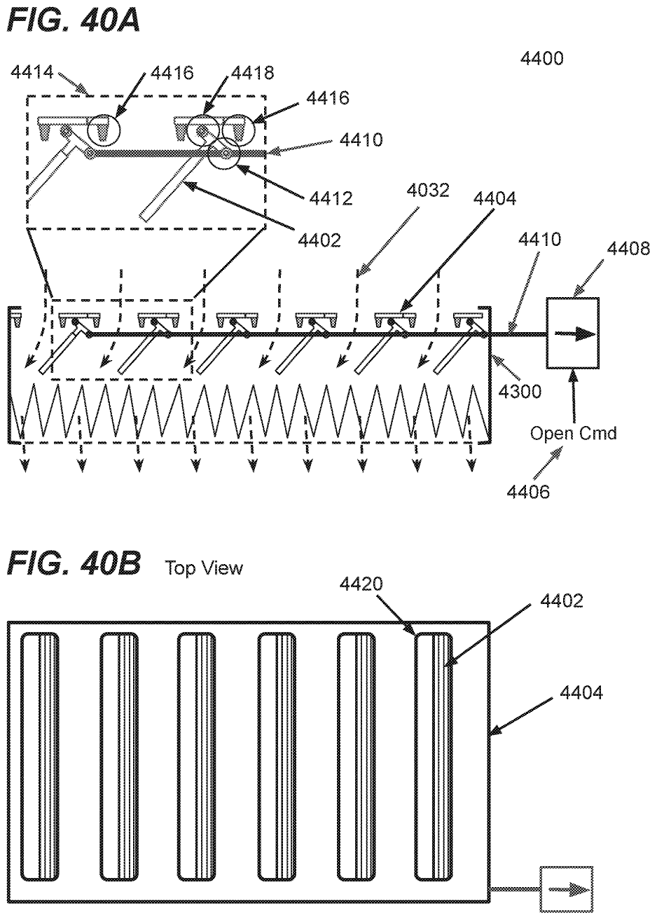

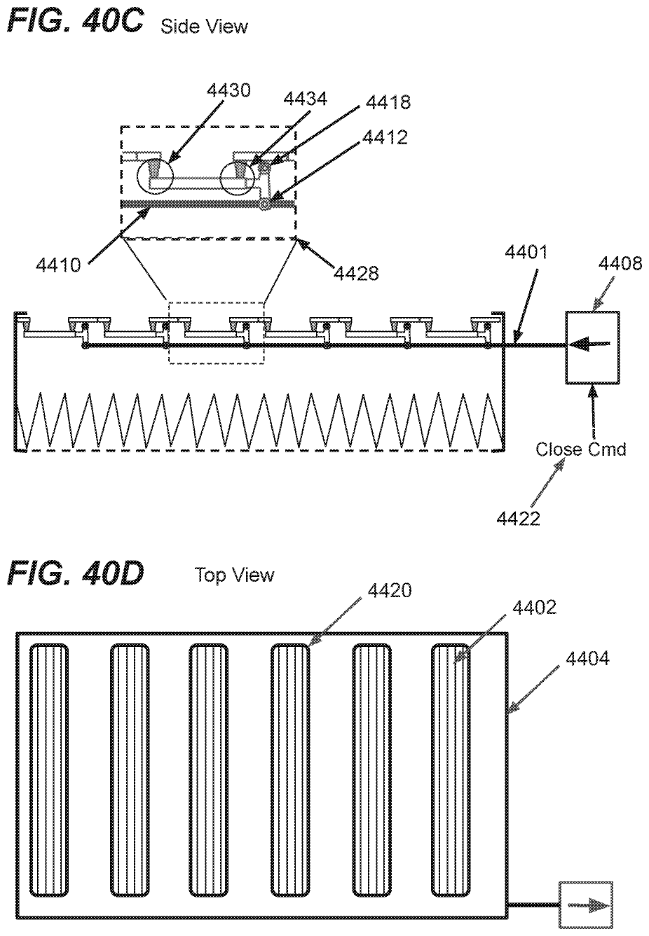

The fines filter frame 4306 is designed to mount in the worksurface plenum 4018 below the resistance filter stack 4008. However, in a microgravity or low gravity environment, particles landing on the fines filter surface and being held there by the passage of air can simply lift off if the airflow is disrupted, and reenter the air volume above the fines filter, and thereafter diffuse through the coarser pores of the resistance filter stack 4008 and reenter the space habitat where they again become a danger. For this reason, FIG. 40A shows a side cross-section of a self-sealing fines filter 4400 with the filter sealing slats 4402 open. The purpose of the self-sealing fines filter 4400 is to nearly completely remove micron- and sub-micron-sized particles from the improved downdraft workstation 4000's diffuser outflow 4034, making it safe to examine lunar samples and equipment on the improved downdraft workstation 4000, even when inside a manned lunar habitat. The self-sealing feature prevents trapped particles from escaping into the habitat even when the workstation's power is off. This capability will enable more in-depth scientific exploration of lunar surface materials and provide a safer way to repair equipment indoors that has been exposed to lunar regolith.

FIG. 40B shows a top view of how filter sealing slats 4402 are positioned in a sealing frame 4404 that seals over the top of the fire-safe fines filter 4300. When open command 4406 is applied to sealing slat actuator 4408, slat actuating rod 4410 pulls on the lever pivot 4412 and rotates filter sealing slats 4402 on slat pivot 4418 to open filter sealing slats 4402 over passthrough openings 4420, allowing downdraft air currents 4032 to pass through the fire-safe fines filter 4300. Magnified view 4414 shows the elastomeric seal 4416 positioning such that when filter sealing slats 4402 closes, it will compress the elastomeric seal 4416 and seal the passthrough openings 4420. The filter sealing slats 4402 would typically be made of smooth-surfaced aluminum and would seal sufficiently to prevent the passage of the finest particles of regolith, as small as 0.1 micron, when pressed against the elastomeric seal 4416 by the slat actuating rod 4410 acting on the lever pivot 4412. Elastomeric seals 4416 are typically made of a soft material like Viton or other elastomers considered fire and outgassing-safe for space habitats.

FIG. 40C shows the side cross-section of the self-sealing fines filter 4400 in closed mode. When a close command 4422 is given to sealing slat actuator 4408, then slat actuating rod 4410 pushes on lever pivot 4412, rotating filter sealing slats 4402 on slat pivot 4418 until filter sealing slats 4402 is pressed against, and compresses elastomeric seals 4416 at sealing contact lines 4430 and 4434 shown in 2nd magnified view 4428 around the periphery of passthrough openings 4420 such that submicron particles cannot seep out of the self-sealing fines filter 4400 when closed.

FIG. 40D shows top view of the filter sealing slats in closed mode

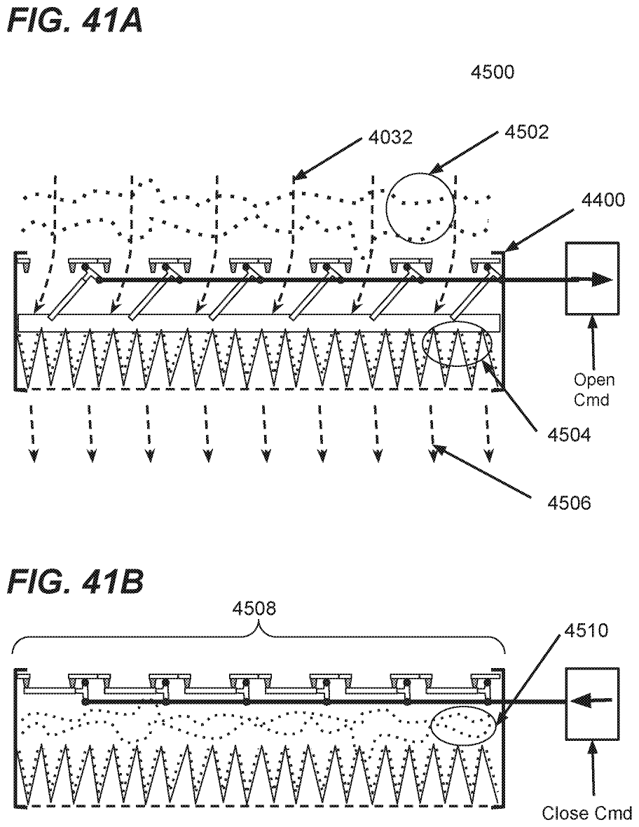

FIG. 41A shows the fines sealing filter in free-flow filtration 4500. In this mode, downdraft air currents 4032 carry airborne particulate fines 4502 into the body of the self-sealing fines filter 4400, where particulate fines rest upon, or embed into, fines filter surface 4504. The result is fines-removed airflow 4506 that can be safely circulated within a space habitat.

FIG. 41B shows the fines sealing filter in sealed-mode 4508, where levitated fines 4510 are safely sealed within the fines sealing filter in sealed-mode 4508.

FIG. 42 shows a downdraft workstation 4600 with powered-up ducted fan module 4004 and self-sealing fines filter in-operation. FIG. 42 further shows the improved downdraft workstation 4000 with a self-sealing fines filter 4400 installed and in fines sealing filter in free-flow filtration 4500 mode. Downdraft air currents 4032 move mixed airborne particulates 4602 down against the surface of resistance filter stack 4008 while the smallest particulate fines 4604 are pulled through the resistance filter stack 4008 by fan airflow 4024 and further through the passthrough openings 4420 of the fines sealing filter in free-flow filtration 4500. Uncaptured fines 4604 then rest upon or embed into fines filter surface 4504 while fines-removed airflow 4506 proceeds through the ducted fan module 4004 and outflow diffuser module 4006.

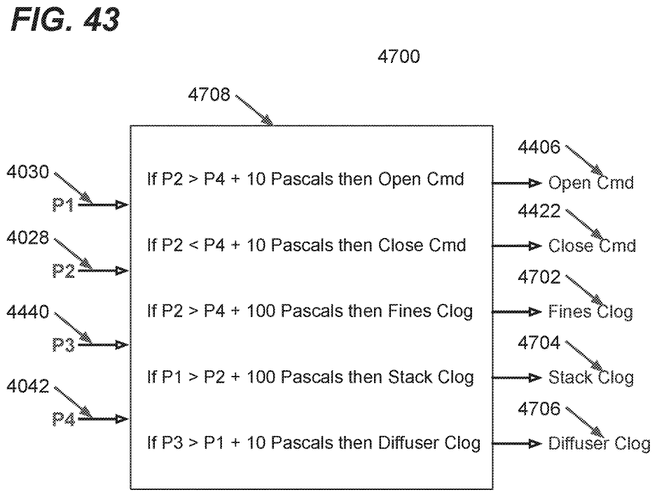

FIG. 43 shows Self-sealing fines filter controller 4700. P1, P2, P3, and P4 are common electronic pressure sensor modules mounted inside or outside the workstation plenums, as shown in FIG. 46. The pressure sensors may be similar to the AMS5812-0150-A absolute pressure sensor manufactured by Analog Microelectronics. The microcontroller 4708 is a commonly available device with an I2C interface and digital relay output ports or their equivalent. The sealing slat actuator 4408 may be based on an electric motor drive, a magnetic solenoid, or other common means for the fines filter controller 4700 to digitally control the open or closed status of the filter sealing slats 4402. In addition to the filter sealing slat method, any other valving method for the self-sealing fines filter 4400 that would open or close the passage of downdraft air currents 4032 through the area above the pleated filter media 4302 would suffice as long as it could prevent the seepage of the smallest particulate fines 4604 outside the interior cavity of the self-sealing fines filter 4400.

As shown in FIG. 43, when the P2 resistive filter stack pressure 4028 is more than 10 pascals higher than the P4 fines filter exit pressure 4042, the sealing slat open command 4406 will be issued to the sealing slat actuator 4408, because airflow can only enter under this condition. Otherwise, the filter will remain sealed, preventing any trapped particles from drifting into the space habitat. Also, as shown in FIG. 47, the pressure sensors can indicate filter clogging by illuminating an indicator light.

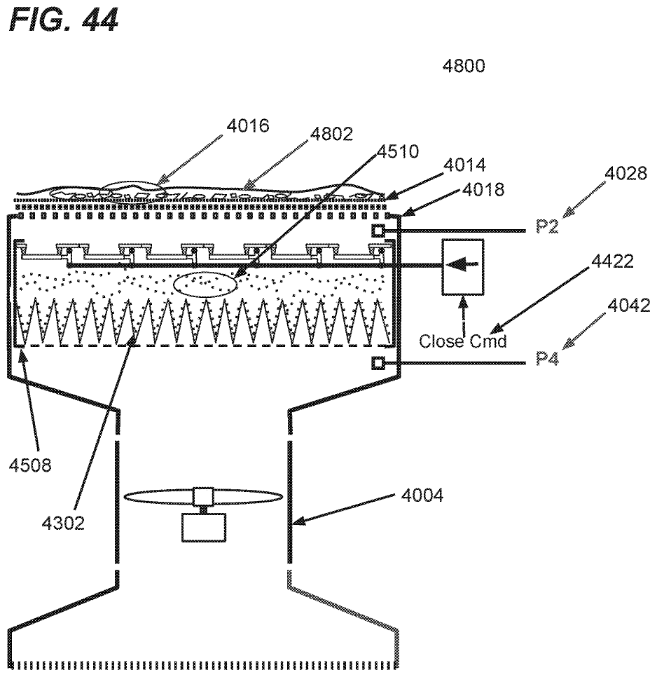

FIG. 44 shows the improved downdraft workstation with self-sealing filter in powered-down mode 4800. To enter powered-down mode, during the time ducted fan module 4004 is still powered on, impermeable layer 4038 is unrolled over the top of smooth worksurface filter 4014, then fastened to the top edge of worksurface plenum 4018 using a string of magnetic strips or preferably a sealing zipper. In this configuration, the unrolled impermeable layer 4802 prevents any loose debris 4016 from lifting off the smooth worksurface filter 4014. In this configuration, downdraft air currents 4032 are blocked off from passing through pleated filter media 4302. With the flow blocked off, the pressure difference between the P2 resistive filter stack pressure 4028 and the P4 fines filter exit pressure 4042 becomes zero, and, in accordance with the conditions shown in FIG. 47, the close command 4422 is issued, causing the self-sealing fines filter 4400 to enter sealed-mode 4508. Ducted fan module 4004 can then be powered down. In the case that there are no loose debris 4016 to be of concern, and the impermeable layer 4038 does not need to be unrolled to seal over the smooth worksurface filter 4014, then the ducted fan module 4004 can be directly powered down, causing the pressure difference across pleated filter media 4302 to become zero, causing the self-sealing fines filter 4400 to enter sealed-mode 4508.

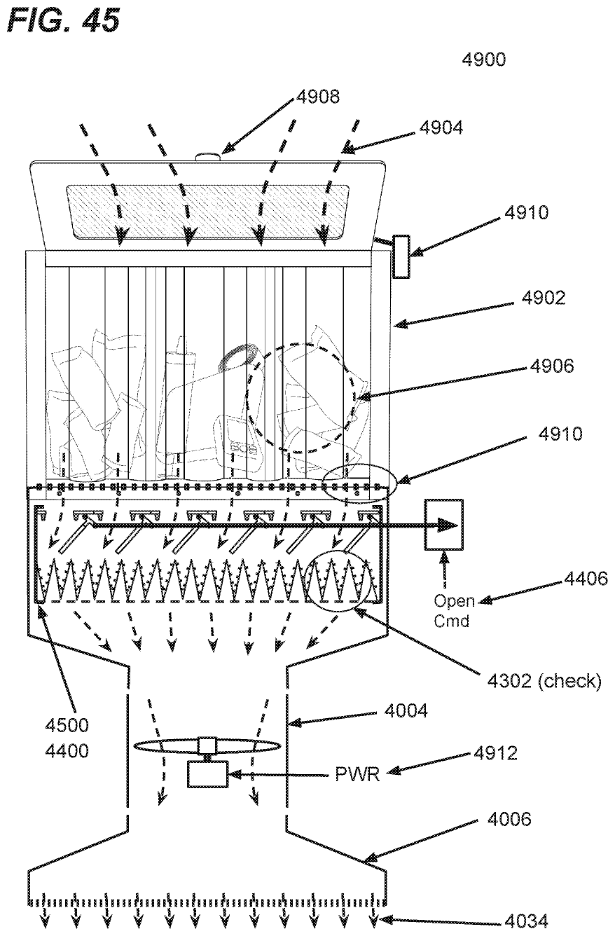

FIG. 45 shows the improved cubby mated with self-sealing fines filter system. The improved cubby in-draft storage locker 4902 is shown mated through worksurface plenum 4018 and support grill 4010 to a self-sealing fines filter 4400. In this configuration, ducted fan module 4004 draws input air currents 4904 through improved cubby in-draft storage locker 4902, past cubby contents 4906 being drawn in by air flow, through support grill 4010, through the fines sealing filter in free-flow filtration 4500, and out through outflow diffuser module 4006. The advantage of this combined system is that if cubby contents 4906 spill fine particulates into the airflow, then the self-sealing fines filter 4400 can both prevent them from entering diffuser outflow 4034 and securely capture the spillage from escaping into the space habitat or back into the improved cubby in-draft storage locker 4902. In operation, when in-draft storage locker door 4908 is opened, door switch 4910 is triggered, which applies fan operating power 4912 to the ducted fan module 4004, and gives the sealing slat open command 4406, enabling the self-sealing fines sealing filter to be in fines sealing filter in free-flow filtration 4500 mode. In this application, the pleated filter media 4302 need only be of the filtration specification needed to support the types of cubby contents 4906 being stored.

Although the invention has been described with reference to the embodiments illustrated in the attached drawing figures, it is noted that equivalents may be employed and substitutions made herein without departing from the scope of the invention as recited in the claims.

What is claimed is:

1. A storage system for use in a microgravity environment, comprising:
a cubby housing defining an interior cavity configured to receive a plurality of objects;
an air-permeable bottom structure disposed at a lower portion of the cubby housing;
a blower system configured to draw air from within the cubby housing through the air-permeable bottom structure; and
a plenum in fluid communication with the blower system,
wherein operation of the blower system generates airflow into the cubby housing that urges the plurality of objects toward the air-permeable bottom structure to restrain the objects from floating.

2. The storage system of claim 1, wherein the blower system comprises a backward-curved impeller configured to draw air axially and discharge air radially.

3. The storage system of claim 1, further comprising a controller configured to activate the blower system in response to opening of a cubby door.

4. The storage system of claim 1, wherein the cubby housing includes one or more interior walls having corrugations aligned with airflow to maintain airflow around objects contacting the walls.

5. The storage system of claim 1, further comprising one or more bottom baffles spaced above the air-permeable bottom structure to prevent objects from occluding airflow.

6. The storage system of claim 1, further comprising a resistance filter assembly including a filter layer supported by a structural grill at the air-permeable bottom structure.

7. The storage system of claim 1, further comprising at least one removable divider configured to partition the interior cavity into multiple sub-cavities, wherein the divider includes airflow passages to maintain airflow around objects contacting the dividers.

8. The storage system of claim 7, wherein the divider is receivable in slots formed along interior walls of the cubby housing.

9. A modular downdraft workstation for a reduced-gravity environment, comprising:
a worksurface module including a plenum and a resistive filter stack forming a worksurface;
a fan module configured to draw air through the resistive filter stack; and
an outflow diffuser module configured to distribute airflow exhausted from the fan module,
wherein the modules are fluidly connected and physically separable to enable independent placement within a habitat.

10. The workstation of claim 9, further comprising extension ducting configured to fluidly couple the worksurface module to the fan module while allowing spatial separation.

11. The workstation of claim 9, wherein the diffuser module includes a flexible fabric diffuser configured to reduce airflow exit velocity.

12. The workstation of claim 9, wherein the resistive filter stack includes:
a support structure;
a compliant filter layer; and
a removable outer worksurface filter layer.

13. A particulate filtration system comprising:
a pleated filter media disposed within a filter housing;
a plurality of movable sealing members positioned adjacent openings above the filter media; and
an actuator configured to move the sealing members between an open position allowing airflow through the filter media and a closed position sealing the openings,
wherein the sealing members prevent release of captured particulate when airflow is reduced or stopped.

14. The filtration system of claim 13, wherein the sealing members comprise slats pivotable about respective axes.

15. The filtration system of claim 13, further comprising elastomeric seals configured to engage the sealing members in the closed position to form an airtight seal.

16. The filtration system of claim 13, wherein the actuator comprises a motor-driven linkage configured to simultaneously actuate a plurality of sealing members.

17. The filtration system of claim 13, wherein the filter media comprises a pleated high-efficiency membrane configured to capture submicron particles.

18. The filtration system of claim 13, further comprising:
a plurality of pressure sensors configured to measure pressures at different locations in an airflow path; and
a controller configured to actuate the sealing members based on comparisons of the measured pressures.

19. The filtration system of claim 18, wherein the controller is configured to:
open the sealing members when an upstream pressure exceeds a downstream pressure by a threshold; and
close the sealing members when the pressure difference falls below the threshold.

20. The filtration system of claim 18, wherein the controller is further configured to detect filter clogging based on pressure differentials.

21. A microgravity storage and filtration apparatus comprising:
a cubby configured to receive objects and draw airflow inward;
a downdraft airflow system coupled to the cubby; and
a self-sealing particulate filter disposed downstream of the cubby,
wherein particulates released from objects within the cubby are captured by the filter and retained when airflow is stopped.

22. The apparatus of claim 21, further comprising a door switch configured to activate the airflow system upon opening the cubby.

23. The apparatus of claim 21, wherein operation of the airflow system simultaneously:
draws objects toward an interior regions of the cubby; and
transports airborne particulates to the filter.

24. The apparatus of claim 21, wherein the self-sealing filter automatically transitions to a sealed state upon power loss.
